(19) United States
(12) Patent Application Publication
(10) Pub. No.: US 2023/0337238 A1
(43) Pub. Date: Oct. 19, 2023

(54) TERMINAL, RADIO COMMUNICATION METHOD, AND BASE STATION

(71) Applicant: NTT DOCOMO, INC., Tokyo (JP)

(72) Inventors: Yuki Takahashi, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/040,223

(22) PCT Filed: Aug. 11, 2020
(86) PCT No.: PCT/JP2020/030618

§ 371 Date: Feb. 1, 2023

(51) Int. Cl. H04W 72/21; H04W 72/566

(52) U.S. Cl. CPC H04W 72/21; H04W 72/566

(57) ABSTRACT

A terminal according to an aspect of the present disclosure includes: a receiving section configured to receive information on a priority corresponding to a physical uplink control channel; and a control section configured to, when a plurality of the physical uplink control channels having different priorities overlap each other in a time domain, determine, based on a format of each physical uplink control channel, whether or not to transmit uplink control information corresponding to each physical uplink control channel, and the physical uplink control channel to be used for transmission of the uplink control information corresponding to each physical uplink control channel.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing data rates, providing low latency, and the like (Non Patent Literature 1). In addition, the specifications of LTE-Advanced (3GPP Rel. 10 to 14) have been drafted for the purpose of further increasing capacity and advancement of LTE (third generation partnership project (3GPP) release (Rel.) 8 and 9).

Successor systems to LTE (for example, also referred to as 5th generation mobile communication system (5G), 5G+ (plus), New Radio (NR), or 3GPP Rel. 15 or later) are also being studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

Future radio communication systems (for example, 5G, NR, and the like) are expected to involve a plurality of services (also referred to as use cases, communication types, or the like) having different communication requirements such as higher speed and larger capacity (for example, enhanced mobile broad band (eMBB)), a massive amount of terminals (for example, massive machine type communication (mMTC) or Internet of Things (IoT)), and ultrahigh reliability and low latency (for example, ultra-reliable and low-latency communications (URLLC)).

For example, in Rel. 16 and later, it is considered that priority is configured for a signal/channel and communication is controlled based on the priority configured for each signal/channel. For example, in a case where a plurality of signals/channels overlap each other, it is assumed that transmission/reception is controlled based on the priority of each signal/channel.

Meanwhile, it is also conceivable that a plurality of UL transmissions respectively transmitted on different carriers (or a cell, CC) overlap each other in the time domain, and priorities of the plurality of UL transmissions are different. In this manner, the way of controlling the UL transmission when a plurality of UL transmissions having different priorities is configured/scheduled in the same time domain on different carriers has not been sufficiently studied.

Therefore, an object of the present disclosure is to provide a terminal, a radio communication method, and a base station capable of appropriately controlling one or more UL transmissions in which priority configuration is supported.

### Solution to Problem

A terminal according to an aspect of the present disclosure includes: a receiving section configured to receive information on a priority corresponding to a physical uplink control channel; and a control section configured to, when a plurality of the physical uplink control channels having different priorities overlap each other in a time domain, determine, based on a format of each physical uplink control channel, whether or not to transmit uplink control information corresponding to each physical uplink control channel, and the physical uplink control channel to be used for transmission of the uplink control information corresponding to each physical uplink control channel.

### Advantageous Effects of Invention

According to one aspect of the present disclosure, one or more UL transmissions in which priority configuration is supported can be appropriately controlled.

### BRIEF DESCRIPTION OF DRAWINGS

FIG. 1 is a diagram illustrating an example of transmission of a HARQ-ACK to a PDSCH.

FIG. 2 is a diagram illustrating an example of PUCCH resource set configuration.

FIG. 3 is a diagram illustrating an example of a PUCCH resource designated by DCI.

FIG. 4A and FIG. 4B are diagrams illustrating an example of UL transmission control based on priority.

FIG. 5 is a diagram illustrating another example of the UL transmission control based on the priority.

FIG. 6 is a diagram illustrating an example of a case where a plurality of HARQ-ACK codebooks is transmitted in a given slot.

FIG. 7 is a diagram illustrating an example of a case where the plurality of HARQ-ACK codebooks overlap each other in the time domain.

FIG. 8 is a diagram illustrating an example of UL transmission control in a first aspect.

FIG. 9 is a diagram illustrating an example of a PUCCH resource set determining method in the first aspect.

FIG. 10 is a diagram illustrating another example of the PUCCH resource set determining method in the first aspect.

FIG. 11 is a diagram illustrating an example of a method of adjusting combined UCI bits in the first aspect.

FIG. 12 is a diagram illustrating an example of UL transmission control in a second aspect.

FIG. 13A and FIG. 13B are diagrams illustrating another example of the UL transmission control in the second aspect.

FIG. 14A and FIG. 14B are diagrams illustrating another example of the UL transmission control in the second aspect.

FIG. 15 is a diagram illustrating an example of the UL transmission control in the second aspect.

FIG. 16 is a diagram illustrating an example of a schematic configuration of a radio communication system according to one embodiment.

FIG. 17 is a diagram illustrating an example of a configuration of a base station according to one embodiment.

FIG. 18 is a diagram illustrating an example of a configuration of a user terminal according to one embodiment.

FIG. 19 is a diagram illustrating an example of a hardware configuration of the base station and the user terminal according to one embodiment.

### DESCRIPTION OF EMBODIMENTS

### Traffic Type

Future radio communication systems (for example, NR) are expected to involve traffic types (also referred to as services, service types, communication types, use cases, or the like) such as an enhanced mobile broadband (eMBB), machine type communications that embody multiple simultaneous connection (for example, massive machine type communications (mMTC), and Internet of Things (IoT)), and ultra-reliable and low-latency communications (URLLC). For example, it is required that URLLC have smaller latency and higher reliability than eMBB.

The traffic type may be identified in a physical layer based on at least one of the followings:
Logical channels with different priorities
Modulation and coding scheme (MCS) table (MCS index table)
Channel quality indication (CQI) table
DCI format
System information-radio network temporary identifier (RNTI) used for scrambling (masking) of cyclic redundancy check (CRC) bit included in (added to) DCI (DCI format)
Radio resource control (RRC) parameter
Specific RNTI (for example, RNTI for URLLC, MCS-C-RNTI, or the like)
Search space
Given field in DCI (for example, newly added field or reuse of existing field)

Specifically, a traffic type of the HARQ-ACK for a PDSCH may be determined based on at least one of the followings:
MCS index table used to determine at least one of the modulation order, target code rate, and transport block size (TBS) of the PDSCH (for example, whether or not to use MCS index table 3)
RNTI used for CRC scrambling of DCI used for scheduling the PDSCH (for example, whether CRC scrambled with C-RNTI or MCS-C-RNTI)

A traffic type of the SR may be determined based on a higher layer parameter used as an SR identifier (SR-ID). The higher layer parameter may indicate whether the traffic type of the SR is eMBB or URLLC.

A traffic type of the CSI may be determined based on configuration information related to CSI report (CSI report setting), a DCI type used for triggering, a DCI transmission parameter, or the like. The configuration information, the DCI type, or the like may indicate whether the traffic type of the CSI is eMBB or URLLC. The configuration information may be a higher layer parameter.

A traffic type of the PUSCH may be determined based on at least one of the followings:
MCS index table used to determine at least one of modulation order, target code rate, and TBS of PUSCH (for example, whether or not to use MCS index table 3)
RNTI used for CRC scrambling of DCI used for scheduling the PUSCH (for example, whether CRC scrambled with C-RNTI or MCS-C-RNTI)

The traffic type may be associated with communication requirements (requirements and required conditions such as latency and error rate), a data type (voice, data, and the like), or the like.

A difference between URLLC requirements and eMBB requirements may be that URLLC is lower in latency than eMBB or that URLLC requirements include reliability requirements.

For example, eMBB user (U)-plane latency requirements may include that downlink U-plane latency is 4 ms and that uplink U-plane latency is 4 ms. Meanwhile, URLLC U-plane latency requirements may include that downlink U-plane latency is 0.5 ms and that uplink U-plane latency is 0.5 ms. Furthermore, the URLLC reliability requirements may include that a 32-byte error rate is 10⁻⁵ for a U-plane latency of 1 ms.

Further, enhancement of the reliability of traffic for unicast data is mainly studied as enhanced ultra reliable and low latency communications (eURLLC). Hereinafter, in a case where URLLC and eURLLC are not distinguished, they are simply referred to as URLLC.

### PUCCH Resource

In the existing radio communication system (for example, Rel. 15), a PUCCH resource to be used for transmission of HARQ-ACK for DL transmission (for example, PDSCH) is determined based on information notified by DCI and higher layer signaling, respectively. For example, UE may determine the PUCCH resource to be used for transmission of the HARQ-ACK using the following steps 1 to 3. Note that the order of steps 1 to 3 may be changed.

### [Step 1]

In step 1, the UE or a terminal (hereinafter, also simply referred to as UE) determines a feedback timing (K1) of the HARQ-ACK. K1 corresponds to a period (for example, slot) from reception of DL transmission (for example, PDSCH) to transmission of the HARQ-ACK for the DL transmission. Information on the HARQ-ACK timing (K1) may be included in the DCI used for scheduling the PDSCH.

A network (for example, base station) may notify the UE of K1 using a given field of the DCI (or PDCCH) for scheduling the PDSCH. For example, a bit value specified in the given field of the DCI may be associated with a given value (for example, {1, 2, 3, 4, 5, 6, 7, 8}). Alternatively, the bit value specified in the given field of the DCI may be associated with a value configured in higher layer signaling.

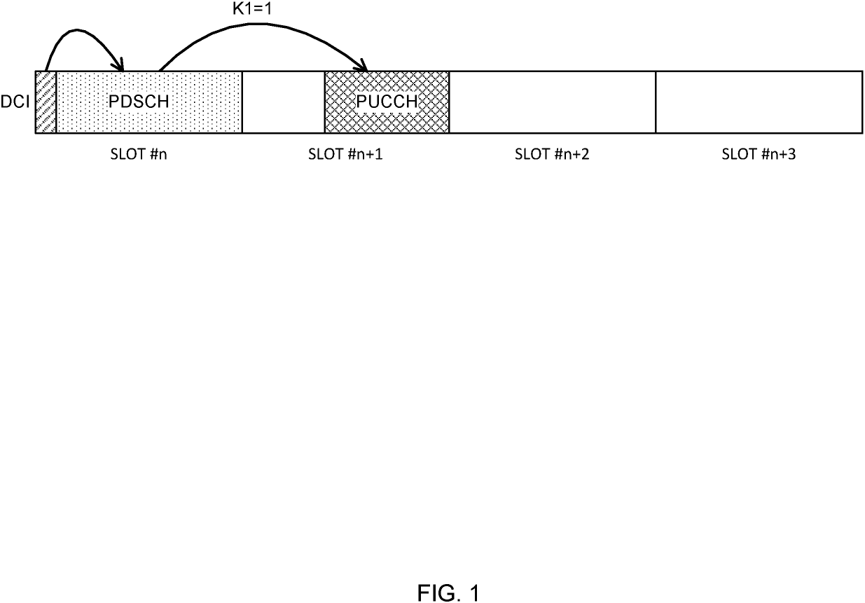

When receiving the DCI for scheduling the PDSCH, the UE determines a timing of feeding back the HARQ-ACK for the PDSCH based on the information included in the DCI (refer to FIG. 1). In FIG. 1, the UE receives the PDSCH scheduled in the same slot #n based on the DCI transmitted in slot #n. In addition, the UE transmits the HARQ-ACK using the PUCCH resource configured in the slot #n+1 based on the information (here, K1 = 1) regarding the HARQ-ACK feedback timing included in the DCI.

### [Step 2]

In step 2, the UE determines a PUCCH resource set to be used in the slot in which the HARQ-ACK is transmitted.

One or more PUCCH resource sets are notified (or configured) to the UE by higher layer signaling. The PUCCH resource set may include one or more PUCCH resources. For example, K (for example, 1 ≤ K ≤ 4) PUCCH resource sets may be notified from the base station to the UE. Each PUCCH resource set may include M (for example, 8 ≤ M ≤ 32, or 1 ≤ M ≤ 8) PUCCH resources.

The UE may determine a single PUCCH resource set from the configured K PUCCH resource sets based on a payload size (UCI payload size) of the UCI. The UCI payload size may be the number of UCI bits that do not include cyclic redundancy code (CRC) bits.

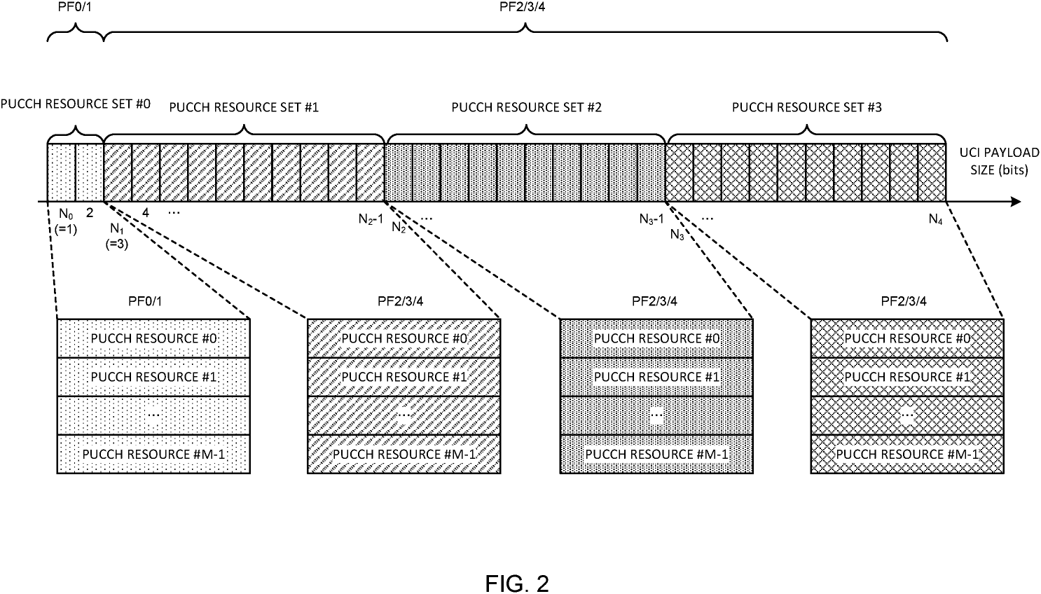

FIG. 2 is a diagram illustrating an example of PUCCH resource allocation. In FIG. 2, as an example, K = 4, and four PUCCH resource sets #0 to #3 are configured by higher layer signaling from the base station to the UE. Each of the PUCCH resource sets #0 to #3 includes M (for example, 8 ≤ M ≤ 32) PUCCH resources #0 to #M-1. The number of PUCCH resources included in each PUCCH resource set may be the same or different.

In FIG. 2, each PUCCH resource configured in the UE may include a value of at least one parameter (also referred to as a field, information, or the like) below. Note that a range of values that can be taken for each PUCCH format may be determined for each parameter.
· Symbol in which PUCCH allocation is started (starting symbol)
Number of symbols allocated to PUCCH in slot (period allocated to PUCCH)
Index of resource block (physical resource block (PRB)) in which PUCCH allocation is started
Number of PRBs allocated to PUCCH
Whether or not to enable frequency hopping on PUCCH
Frequency resource of second hop when frequency hopping is enabled, index of initial cyclic shift (CS)
Index of orthogonal spreading code (for example, OCC: Orthogonal Cover Code) in the time domain, length (also referred to as OCC length, spreading factor or the like) of OCC used for block-wise spreading before discrete Fourier transform (DFT)
Index of OCC used for block-wise spreading after DFT

As shown in FIG. 2, when PUCCH resource sets #0 to #3 are configured for the UE, the UE selects any one of the PUCCH resource sets based on the UCI payload size.

For example, when the UCI payload size is one or two bits, the PUCCH resource set #0 is selected. Further, when the UCI payload size is greater than or equal to three bits and less than or equal to N₂-1 bits, a PUCCH resource set #1 is selected. Further, when the UCI payload size is greater than or equal to N₂ bits and less than or equal to N₃-1 bits, the PUCCH resource set #2 is selected. Similarly, when the UCI payload size is greater than or equal to N₃ bits and less than or equal to N₃-1 bits, the PUCCH resource set #3 is selected.

In this way, the range of the UCI payload size in which the PUCCH resource set #i (i = 0,.., K-1) is selected is indicated as Nᵢ bits or more and Nᵢ₊₁-1 bits or less (That is, {Nᵢ,.., Nᵢ₊₁-1} bits).

Here, the starting positions (starting bit numbers) N₀ and N₁ of the UCI payload sizes for the PUCCH resource sets #0 and #1 may be 1 and 3, respectively. As a result, since the PUCCH resource set #0 is selected when the UCI of two bits or less is transmitted, the PUCCH resource set #0 may include the PUCCH resources #0 to #M-1 for at least one of PF0 and PF1. On the other hand, when the UCI exceeding two bits is transmitted, any one of the PUCCH resource sets #1 to #3 is selected, and thus, the PUCCH resource sets #1 to #3 may include the PUCCH resources #0 to #M-1 for at least one of PF2, PF3, and PF4, respectively.

In a case where i = 2,..., K-1, the information (starting position information) indicating the starting position (Nᵢ) of the payload size of the UCI for the PUCCH resource set #i may be notified (or configured) to the UE using higher layer signaling. The starting position (Nᵢ) may be UE specific. For example, the starting position (Nᵢ) may be configured to a value (for example, multiple of 4) in a range of four bits or more and 256 bits or less. For example, in FIG. 2, the information indicating the starting position (N₂, N₃) of the UCI payload size for the PUCCH resource sets #2 and #3 is notified to the UE in the higher layer signaling (for example, user-specific RRC signaling).

The maximum payload size of the UCI of each PUCCH resource set is given in N_{K}-1. The N_{K} may be explicitly notified (configured) to the UE by higher layer signaling and/or DCI, or may be implicitly derived. For example, in FIG. 2, N₀ = 1 and N₁ = 3 are defined in the specification, and N₂ and N₃ may be notified by higher layer signaling. N₄ may be defined in the specification (for example, N₄ = 1706) .

In this way, the UE selects one PUCCH resource set based on the UCI payload size (for example, if UCI is HARQ-ACK, HARQ-ACK bit) from one or more PUCCH resource sets configured in the higher layer.

### [Step 3]

In step 3, the UE determines one PUCCH resource from one or more PUCCH resources included in the PUCCH resource set.

For example, the UE may determine the PUCCH resource used for the transmission of the UCI based on at least one of the DCI and implicit information (also referred to as implicit indication information, implicit index, or the like) from the M PUCCH resources included in the determined PUCCH resource set.

In the case illustrated in FIG. 2, the user terminal can determine, from the PUCCH resources #0 to #M-1 included in the PUCCH resource set selected based on the UCI payload size, a single PUCCH resource used for transmission of the UCI based on a value of a given field of the DCI.

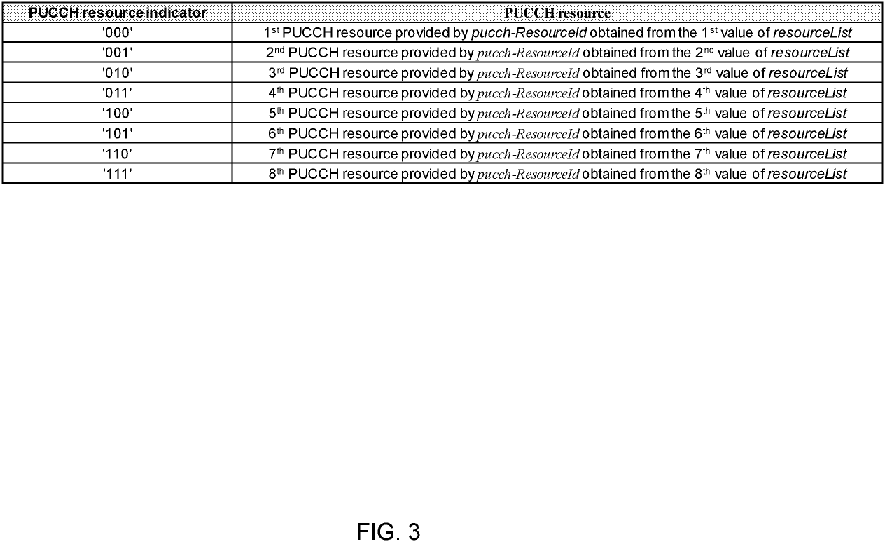

The quantity M of PUCCH resources in one PUCCH resource set may be configured for the user terminal by higher layer signaling (refer to FIG. 3). FIG. 3 illustrates a case where eight PUCCH resources are configured by higher layer signaling. Here, a case where the PUCCH resource in the PUCCH resource set is notified by a 3-bit field in the DCI is illustrated, but the number of bits is not limited thereto.

### Priority Configuration

In NR Rel. 16 and beyond, configuring priorities at a plurality of levels (for example, two levels) for a given signal or channel is being studied. For example, it is assumed that communication is controlled (for example, transmission control at the time of collision, and the like) by configuring different priorities for every signal or channel each corresponding to different traffic types (also referred to as services, service types, communication types, use cases, and the like). This makes it possible to control communication by configuring, for the same signal or channel, different priorities depending on a service type or the like.

The priority may be configured for at least one of a signal (for example, UCI such as HARQ-ACK, reference signal, and the like), a channel (PDSCH, PUSCH, PUCCH, and the like), a reference signal (for example, channel state information (CSI), sounding reference signal (SRS), and the like), a scheduling request (SR), and a HARQ-ACK codebook. In addition, the priority may be configured for each of the PUCCH used for SR transmission, the PUCCH used for HARQ-ACK transmission, and the PUCCH used for CSI transmission.

The priority may be defined by a first priority (for example, high) and a second priority (for example, low) that is lower in priority than the first priority. Alternatively, three or more types of priorities may be configured.

For example, priorities may be respectively configured for HARQ-ACK for a PDSCH that is dynamically scheduled, HARQ-ACK for a semi-persistent PDSCH (semi-persistent scheduling (SPS) PDSCH), and HARQ-ACK for SPS PDSCH release. Alternatively, priorities may be respectively configured for HARQ-ACK codebooks corresponding to these HARQ-ACKs. Note that, in a case where a priority is configured for a PDSCH, the priority of the PDSCH may be replaced with a priority of HARQ-ACK for the PDSCH.

In addition, priorities may be respectively configured for a dynamic grant-based PUSCH, a configured grant-based PUSCH, or the like.

Notification of the information on the priority may be provided from a base station to the UE using at least one of higher layer signaling and DCI. For example, the priority of the scheduling request may be configured by a higher layer parameter (for example, scheduling request priority). The priority of the HARQ-ACK for the PDSCH (for example, dynamic PDSCH) scheduled by the DCI may be notified by the DCI. The priority of the HARQ-ACK for the SPS PDSCH may be configured by a higher parameter (for example, HARQ-ACK-Codebook-indicator-for SPS), or may be notified by DCI indicating activation of the SPS PDSCH. A given priority (for example, low) may be configured to P-CSI/SP-CSI transmitted on the PUCCH. On the other hand, the priority of A-CSI/SP-CSI transmitted using the PUSCH may be notified by DCI (for example, trigger DCI or activation DCI) .

The priority of the dynamic grant-based PUSCH may be notified by the DCI for scheduling the PUSCH. The priority of the configured grant-based PUSCH may be configured by a higher layer parameter (for example, priority). A given priority (for example, low) may be configured to P-SRS/SP-SRS and A-SRS triggered by the DCI (for example, DCI format 0_1/DCI format 2_3).

### (Overlap of UL Transmission)

The UE may control UL transmission based on priority when a plurality of UL signals/UL channels overlap each other (or collide with each other).

A case in which the plurality of UL signals/UL channels overlap each other may be a case in which a time resource (or time resource and frequency resource) of the plurality of UL signals/UL channels overlap each other, or a case in which transmission timings of the plurality of UL signals/UL channels overlap each other. The time resource may be replaced with a time domain. The time resource may be in units of symbols, slots, subslots, or subframes.

The overlapping of the plurality of UL signals/UL channels in the same UE (for example, intra-UE) may mean that the plurality of UL signals/UL channels overlap each other at least in the same time resource (for example, symbol). Further, the UL signal/UL channel colliding in different UEs (for example, inter-UE) may mean that the plurality of UL signal/UL channels overlap each other in the same time resource (for example, symbol) and frequency resource (for example, RB).

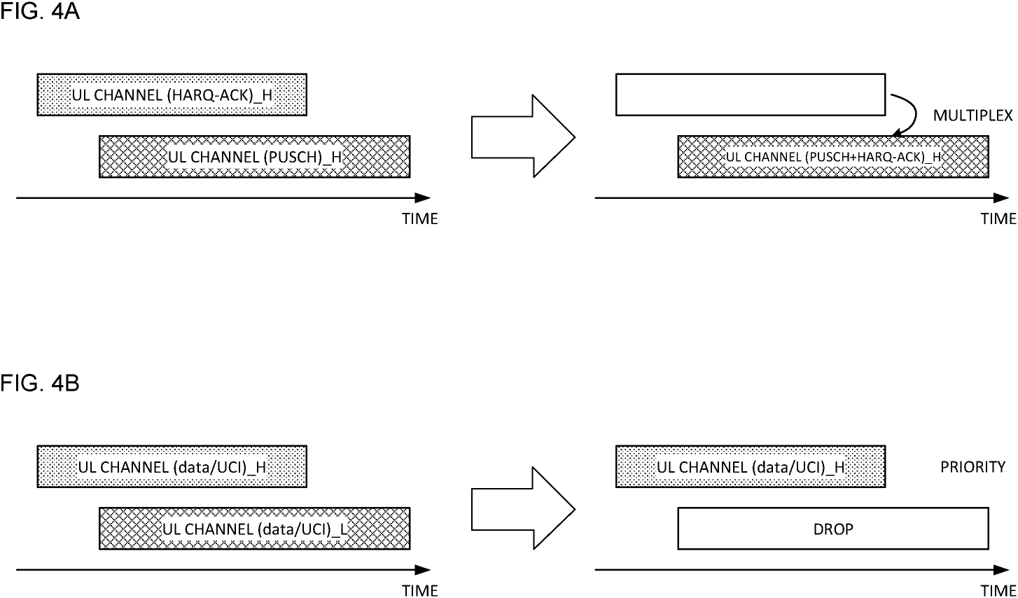

For example, when a plurality of UL signalBSs/UL channels having the same priority overlap each other, the UE performs control to multiplex the plurality of UL signals/UL channels into one UL channel and to transmit the one UL channel (refer to FIG. 4A).

FIG. 4A illustrates a case in which HARQ-ACK (or PUCCH for transmission of HARQ-ACK) in which the first priority (high) is configured and UL data/UL-SCH (or PUSCH for UL data/UL-SCH transmission) in which the first priority (high) is configured overlap each other. In this case, the UE multiplexes (or maps) the HARQ-ACK to the PUSCH and transmits both the UL data and the HARQ-ACK.

When a plurality of UL signals/UL channels having different priorities overlap each other, the UE may perform a control operation so that UL transmission having a high priority is performed (for example, UL transmission having a high priority is prioritized) and UL transmission having a low priority is not performed (for example, drop) (refer to FIG. 4B).

FIG. 4B illustrates a case in which UL data/HARQ-ACK (or UL channel for UL data/HARQ-ACK transmission) in which the first priority (high) is configured and UL data/HARQ-ACK (or UL channel for UL data/HARQ-ACK transmission) in which the second priority (low) is configured overlap each other. In this case, the UE performs control to drop the UL data/HARQ-ACK having a low priority and to prioritize and transmit the UL data/HARQ-ACK having a high priority. Note that the UE may change (for example, defer or shift) a transmission timing of UL transmission having a low priority.

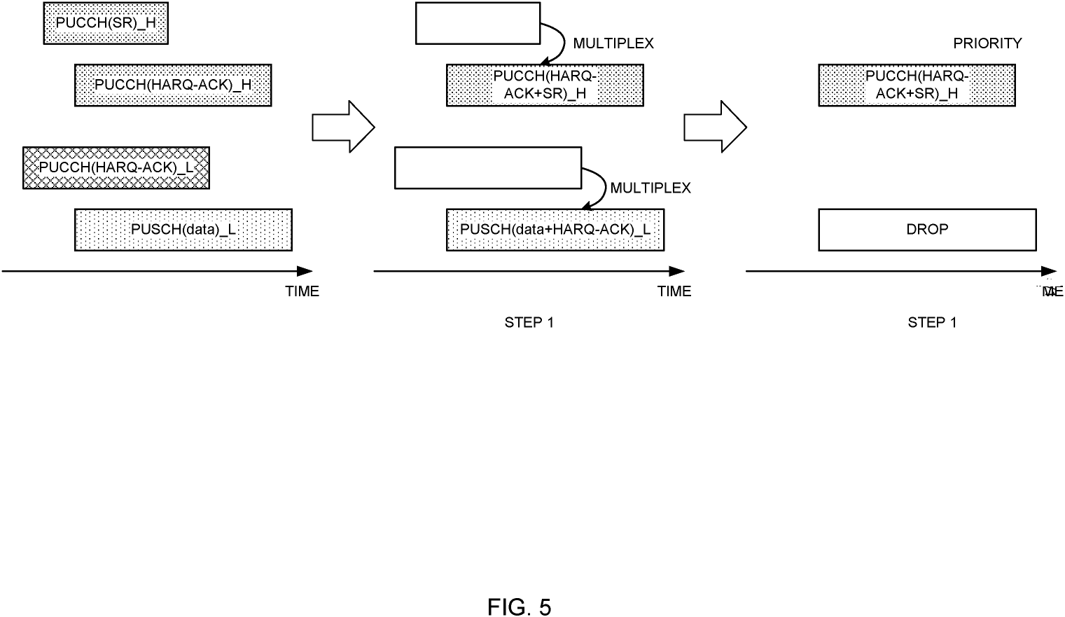

When more than two (or three or more) UL signals/UL channels overlap each other in the time domain, the transmission may be controlled by two steps (refer to FIG. 5) .

In step 1, one UL channel to multiplex UL signals respectively transmitted by UL transmissions having the same priority is selected. In FIG. 5, an SR (or PUCCH for SR transmission) having the first priority (high) and a HARQ-ACK (or PUCCH for transmission of HARQ-ACK) may be multiplexed into a given UL channel (here, PUCCH for transmission of HARQ-ACK). Similarly, HARQ-ACK (or PUCCH for transmission of HARQ-ACK) having the second priority (low) and data (or PUSCH for data/UL-SCH transmission) may be multiplexed into a given UL channel (here, PUSCH).

In step 2, a control operation may be performed so that the UL transmission having a high priority is preferentially transmitted and the UL transmission having a low priority is dropped between the UL transmissions having different priorities. In FIG. 5, the PUCCH for transmission of the SR and the HARQ-ACK having the first priority (high) may be preferentially transmitted, and the PUSCH for transmission of the HARQ-ACK and the data having the second priority (low) may be dropped.

In this way, the UE can resolve collisions between a plurality of UL transmissions having the same priority according to step 1, and resolve collisions between a plurality of UL transmissions having different priorities according to step 2.

### (Multiple HARQ-ACK Codebook)

In Rel. 16 and subsequent, it may be allowed to configure the maximum number of N HARQ-ACK codebooks in a given slot (for example, one slot). N may be, for example, two. For example, when N is two, the UE may configure two codebooks (or codebooks corresponding to different priorities/different service types) for HARQ-ACK having different priorities in a given slot, and feedback the codebooks.

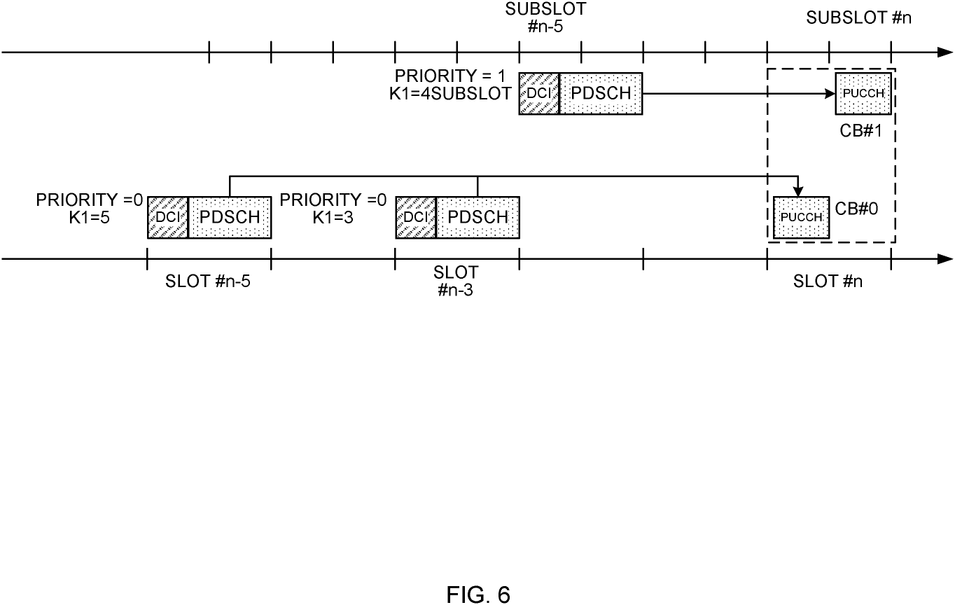

The UE may control the generation (for example, generation of HARQ-ACK bits in the HARQ-ACK codebook) of the HARQ-ACK codebook based on a value of a priority notification field (for example, priority indicator field) included in the DCI corresponding to each PDSCH. FIG. 6 illustrates an example of a case of generating/feeding back two HARQ-ACK codebooks (here, CB #0 and CB #1) corresponding to different priorities in the slot #n. The CB #0 corresponds to the second priority (low) or eMBB, and the CB #1 corresponds to the first priority (high) or URLLC.

In FIG. 6, the DCI corresponding to the PDSCH transmitted in the slot #n-5 notifies that the feedback timing of the HARQ-ACK is the slot #n (K1 = 5) and the second priority (low). The DCI corresponding to the PDSCH transmitted in the slot #n-3 notifies that the feedback timing of the HARQ-ACK is the slot #n (K1 = 3) and the second priority (low).

In FIG. 6, the DCI corresponding to the PDSCH transmitted in the slot #n-2 (subslot #n-4, #n-5) notifies that the feedback timing of the HARQ-ACK is the slot #n (subslot #n) (K1 = 5 subslot) and the first priority (high).

In this case, the UE may generate and feedback two HARQ-ACK codebooks (CB #0 and CB #1) in the slot #n.

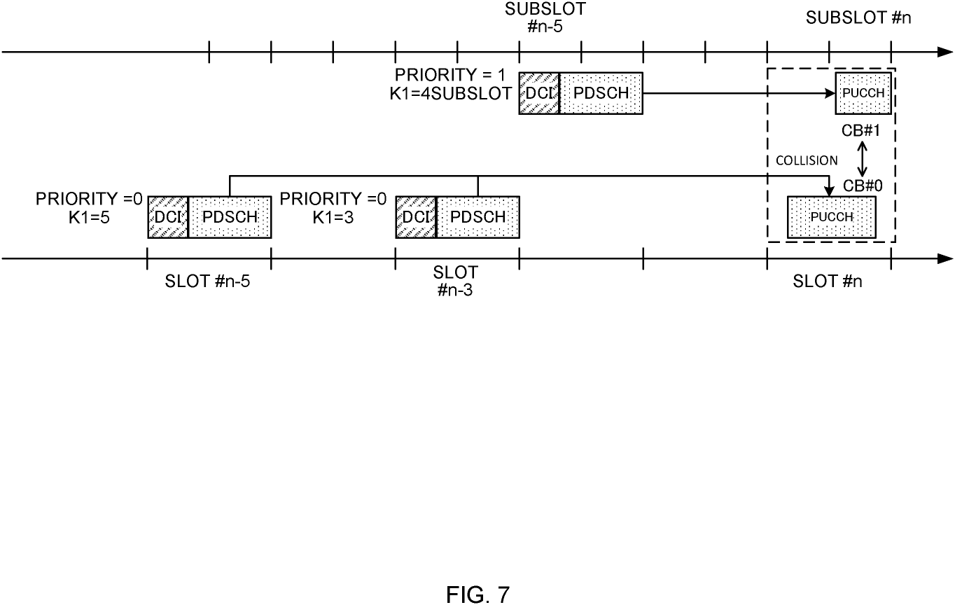

On the other hand, there may be a case in which the UL resource (for example, PUCCH/PUSCH) for CB #0 and the UL resource for CB #1 overlap each other in the time domain (refer to FIG. 7). In such a case, it is conceivable to control the transmission of the HARQ-ACK based on the priority corresponding to the HARQ-ACK (or CB). Specifically, a CB having a higher priority is transmitted, and a CB having a lower priority is dropped.

In this way, when a plurality of UL transmissions overlap each other in the time domain, it is considered that the UE performs control to transmit only the UL transmission (or UL channel/UL signal) having a high priority.

On the other hand, even when a plurality of UL transmissions having different priorities overlap each other in the time domain, it is considered that the plurality of UL transmissions is permitted depending on the communication environment/communication condition/UE capability. The support of the plurality of UL transmissions is useful from the viewpoint of low delay and spectral efficiency.

The communication environment/communication condition/UE capability may be a cell in which each of the plurality of UL transmissions is transmitted, transmission processing/reception processing capability supported by the UE (for example, RF circuit or the like included in UE). For example, in a case where a plurality of UL transmissions having different priorities is scheduled in inter-cells supported by different RFs, the plurality of UL transmissions (for example, simultaneous transmission) may be supported.

However, when transmission of a plurality of UL transmissions having different priorities is supported/allowed, the way of controlling the UL transmission becomes a problem.

The present inventors have focused on the fact that, even in a case where a plurality of UL transmissions having different priorities overlap each other in the time domain, the plurality of UL transmissions is supported/allowed depending on the communication environment/communication condition/UE capability, and have examined the plurality of UL transmission controls to conceive an aspect of the present embodiment.

Specifically, the present inventors have focused on a point that transmission conditions/parameters are separately configured for a plurality of UL channels (for example, PUCCH) overlapping each other in the time domain and having different priorities as one aspect of the embodiment, and have conceived to control transmission of UCI corresponding to each PUCCH based on the transmission conditions/parameters corresponding to each PUCCH. The transmission conditions/parameters corresponding to the PUCCH may be at least one of the PUCCH resource, the PUCCH format, the PUCCH configuration, and the PUCCH resource set.

Hereinafter, embodiments according to the present disclosure will be described in detail with reference to the drawings. The configurations described in each of the aspects may be applied singly or in combination.

In the present disclosure, “A/B” may be read as at least one of A and B, and “A/B/C” may be read as at least one of A, B, and C.

In the following description, two levels of the first priority (high) and the second priority (low) will be described as an example of the priority of the UL transmission, but the priority is not limited to the two levels. Three or more levels of priority may be configured.

In the present disclosure, UL transmission, a UL channel, and a UL signal may be replaced with each other. Further, in the present disclosure, a carrier, a cell, a CC, a BWP, and a band may be replaced with each other. Furthermore, in the present disclosure, “transmitted” may be replaced with scheduled, configured, or allocated. In the present disclosure, the time domain may be replaced with a time resource or a symbol. Furthermore, in the present disclosure, overlapping each other may be replaced with a collision or an overlap. Further, in the present disclosure, dropping may be replaced with puncturing or cancellation.

### (First Aspect)

In a first aspect, an example of UL transmission control in a case where a plurality of UL transmissions having different priorities overlap each other in a time domain will be described.

When a first PUCCH and a second PUCCH overlap each other in the time domain, the UE may control, based on a format of the first PUCCH/a format of the second PUCCH, transmission (for example, presence/absence of transmission/PUCCH used for transmission) of UCI corresponding to each PUCCH. The UCI may be replaced with HARQ-ACK or HARQ-ACK + SR.

In the first aspect, a description will be given as an example as to a case where the first PUCCH corresponding to the first priority (high) and the second PUCCH corresponding to the second priority (low) collide with each other, and the format of the first PUCCH is a given value or more (for example, PUCCH format 2, 3, or 4). The PUCCH format having a given value or more may correspond to a PUCCH format capable of transmitting more than a given bit (for example, two bits) of UCI.

It is assumed that the first PUCCH (high) and the second PUCCH (low) overlap each other in the time domain, and a format of the first PUCCH is a given PF2, 3, or 4. In such a case, the UE may transmit a second UCI corresponding to (or allocated to) the second PUCCH using the first PUCCH.

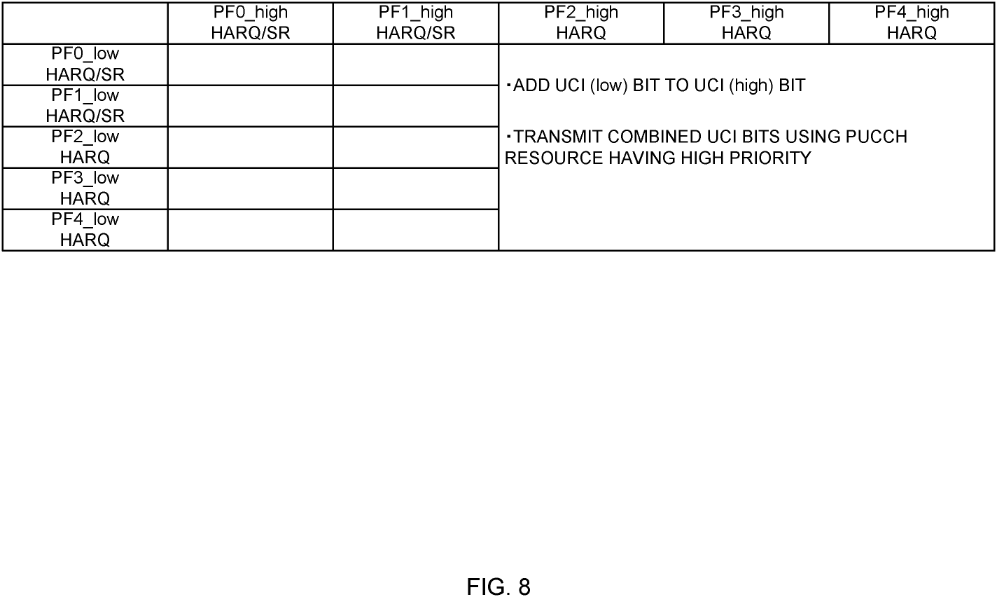

For example, the UE adds the second UCI to a first UCI corresponding to the first PUCCH, and transmits combined UCI bits of the first UCI and the second UCI (for example, combined UCI) using a first PUCCH resource corresponding to the first PUCCH (refer to FIG. 8).

Since PF 2/3/4 supports transmission of more than at least two bits of the UCI, when the first PUCCH applies PF 2/3/4, the combined UCI (first UCI + second UCI) can be appropriately transmitted using the first PUCCH.

Note that the UE may transmit the second UCI using the first PUCCH when a given condition (for example, given timeline) is satisfied. The given timeline may be defined based on a transmission timing of the first PUCCH (or first UCI) and a transmission timing of the second PUCCH (or second UCI).

### Determination of First PUCCH Resource

When transmitting a first UCI bit and a second UCI bit (for example, combined UCI bits) using the first PUCCH, the UE may determine the first PUCCH resource using at least one of the following option A-1 and option A-2.

### [Option A-1]

The UE may perform control to transmit the combined UCI bits using the first PUCCH resource selected based on the first UCI bit. That is, the UE may determine the first PUCCH resource based on the first UCI bit even when mapping the second UCI to the first PUCCH resource (or adding second UCI to first UCI).

In this case, the number of combined UCI bits may be controlled (alternately, limited to a case where the maximum number of bits (Ni) is not exceeded) so as not to exceed the maximum number of bits (Ni) corresponding to a boundary of a PUCCH resource set size configured for the first PUCCH.

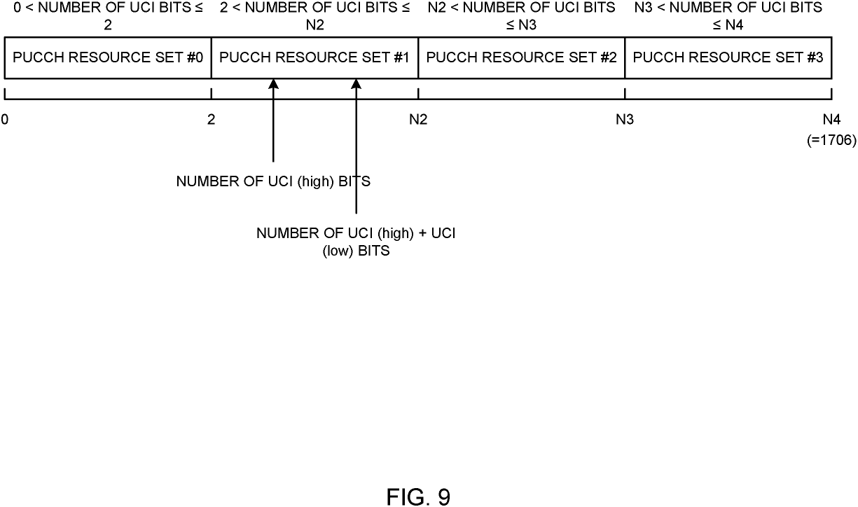

For example, it is assumed that the number of first UCI bits falls within a range (for example, 2 < number of UCI bits ≤ N2) of the PUCCH resource set #1 (refer to FIG. 9). Ni may be a value configured for the first PUCCH. The option A-1 can be advantageously used when the number of combined UCI bits (number of first UCI bits + number of second UCI bits) falls within, or is limited to, the range of the same PUCCH resource set #1 (for example, 2 < number of UCI bits ≤ N2).

When the option A-1 is used, the PUCCH resource set determined based on the first UCI bit may be applied as the first PUCCH resource. That is, since the UE can use the PUCCH resource determined using the same mechanism as that in the case where no PUCCH collision occurs, it is not necessary to reselect the PUCCH.

### Option A-2

The UE may perform control to use the first PUCCH resource selected based on the first UCI bit and the second UCI bit (for example, combined UCI bits) to transmit the combined UCI bits. That is, when mapping the second UCI to the first PUCCH resource (or adding second UCI to first UCI), the UE may determine (or reselect) the first PUCCH resource based on the number of bits obtained by adding the second UCI bit to the first UCI bit.

In this case, the number of combined UCI bits may be controlled (or limited to a case where the maximum number of bits (N4) is not exceeded) so as not to exceed the maximum number of bits (N4) of the PUCCH resource set size configured for the first PUCCH.

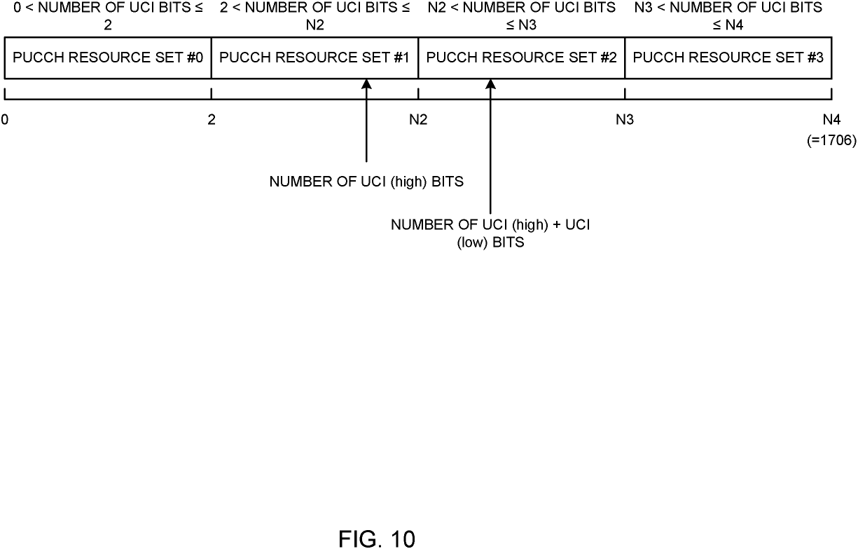

For example, it is assumed that the number of first UCI bits falls within a range (for example, 2 < number of UCI bits ≤ N2) of the PUCCH resource set #1. Ni may be a value configured for the first PUCCH. When the number of combined UCI bits (number of first UCI bits + number of second UCI bits) is not in the range (for example, 2 < number of UCI bits ≤ N2) of the same PUCCH resource set #1, the UE may reselect another PUCCH resource set (for example, here, PUCCH resource set #2) (refer to FIG. 10).

As a result, even when a PUCCH resource set corresponding to the number of first UCI bits is different from a PUCCH resource set corresponding to the number of combined UCI bits, transmission can be performed using an appropriate PUCCH resource set.

### Determination/Adjustment of Combined UCI Bits

When transmitting the first UCI bit and the second UCI bit (for example, combined UCI bits) using the first PUCCH, the UE may determine/adjust the number of combined UCI bits (for example, at least second UCI bit) using at least one of the following option B-1 and option B-2.

### [Option B-1]

When the number of combined UCI bits does not exceed a given value (or less than or equal to the given value), the UE may directly (or as it is) add the second UCI bit to the mapping (or first UCI) on the first PUCCH resource. The given value may be at least one of the maximum number of bits (Ni) corresponding to the boundary of the PUCCH resource set size in the option A-1 and the maximum number of bits (N4) of the PUCCH resource set size in the option A-2.

Alternatively, the given value may be defined in advance in the specification, or may be notified/configured from the base station to the UE by higher layer signaling or the like.

When the total bit value of the first UCI bit and the second UCI bit together exceeds the given value (or when the number of the second UCI bits exceeds the given value), the UE may perform a control operation to transmit a part of the second UCI bits and to drop the rest. The part of the number of second UCI bits to be transmitted may be determined based on the given value, or may be predefined in the specification.

Alternatively, the UE may perform a control operation so as not to transmit the second UCI.

Accordingly, even when the size of the combined bits (first UCI bit + second UCI bit) exceeds a given value (maximum value supported by PUCCH resource), the UL transmission can be appropriately performed.

### [Option B-2]

The UE may perform processing for limiting the number of bits of the second UCI. For example, the UE may perform bundling processing on the second UCI bit, and then map the second UCI bit to the first PUCCH (or add second UCI bit to first UCI). The processing for limiting the number of bits of the second UCI may be applied when the number of second UCI bits exceeds a given value in the option B-1, or may be applied regardless of whether the number of second UCI bits exceeds the given value in the option B-1.

After the UE bundles the second UCI bit, when the number of combined UCI bits exceeds the given value, a control operation may be further performed to transmit a part of the second UCI bits and to drop the rest.

For example, the UE may bundle the second UCI bits so that the second UCI bits become a given number of bits. The given number of bits may be, for example, one bit. Alternatively, the given bit may be defined in the specification, or may be notified/configured from the base station to the UE by higher layer signaling.

Alternatively, the bundling size (or bundling unit) may be notified/configured from the base station to the UE by higher layer signaling. For example, when the bundling size is X, the UE may bundle every X bits (in units of X bits) into one bit for the second UCI bits.

For example, when the second UCI bits are 18 bits and the bundling size is 4, 18 bits are bundled into one bit every four bits. In this case, the second UCI is adjusted from 18 bits to five bits. The UE performs a control operation so as to multiplex/map the adjusted number of second UCI bits (here, five bits) to the first PUCCH resource.

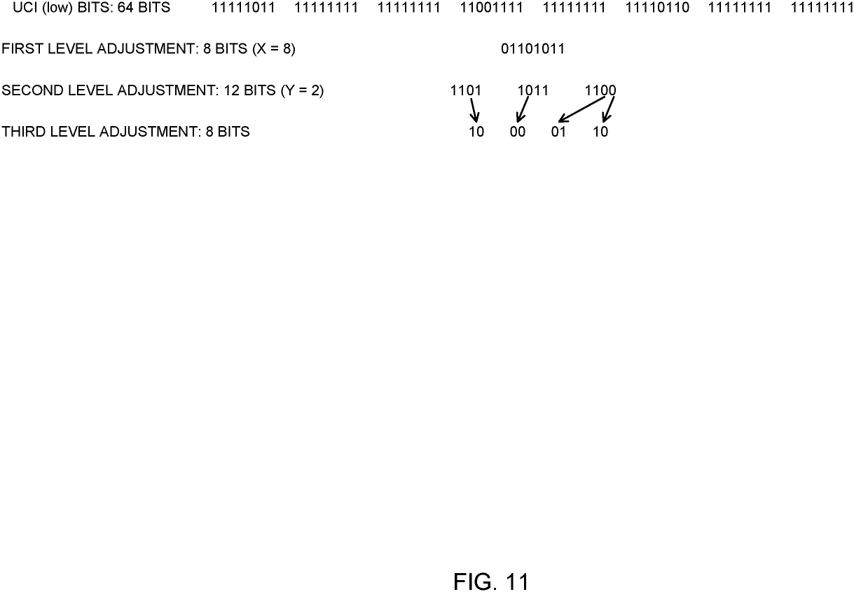

Alternatively, the UE may apply a plurality of levels of adjustment (for example, bundling (for example, multi-level bundling)) to the second UCI bits. When the total size of the combined bits (first UCI bit + second UCI bit) exceeds a given value, the UE may perform a control operation so as to drop bits in order from a high-level bit. FIG. 11 illustrates an example of a case where three levels of bundling is applied.

FIG. 11 illustrates a case where the second UCI bit is 64 bits, eight bits are obtained by first level adjustment (for example, bundling), 12 bits are obtained by second level adjustment (for example, bundling), and eight bits are obtained by third level adjustment. These numerical values are merely examples, and the present disclosure is not limited thereto.

In the first level adjustment, bundling (adjustment to one bit) is performed for the second UCI bit (here, 64 bits) for each X bits (here, X = 8). The UE sets “0” when at least one “0” is included in units of eight bits, and sets “1” when all are “1”. Here, a case where 01101011 is obtained by the first level bundling is illustrated.

In the second level adjustment, bundling (adjustment to one bit) is performed for each Y bits (here, Y = 2) for a group (here, group in units of eight bits) that becomes “0” by the first level adjustment. Here, 1101, 1011, and 1100 are obtained by performing bundling every two bits for three groups (here, 11111011, 11001111, and 11110110) that become “0” by the first level bundling.

In the third level adjustment, for a group (here, group in units of two bits) that becomes “0” by the second level adjustment, an original bit is represented as third level bit information using the Y bit (here, Y = 2). Here, 10, 00, 01, and 10 are obtained as original bits respectively corresponding to four zeros that become “0” by the second-level bundling.

The second UCI bit to be transmitted may be controlled based on the total size of the first UCI bit and the adjusted second UCI bit. For example, when the first UCI bit and the adjusted second UCI bit (for example, 28 bits (eight bits for first level adjustment + 12 bits for second level adjustment + eight bits for third level adjustment)) do not exceed a given value, bits corresponding to the plurality of levels of adjustment (here, 28 bits) may be transmitted as the second UCI bit.

On the other hand, when the first UCI bit and the adjusted second UCI bit (for example, 28 bits) exceed the given value, the UE may drop some or all of the second UCI bits so that the given value is not exceeded. The order of dropping may be bits of the third level adjustment, the second level adjustment, and the first level adjustment. For example, when the first UCI bit and the adjusted second UCI bit (for example, 20 bits (eight bits for first level adjustment + 12 bits for second level adjustment)) do not exceed the given value, bits corresponding to the first and second level adjustments (here, 20 bits) may be transmitted as the second UCI bit.

In this way, even if the original first UCI bit and the second UCI bit exceed the size supported by the first PUCCH resource, the first UCI bit and some of the second UCI bits can be appropriately transmitted by adjusting the number of bits of the second UCI.

### Encoding of Combined UCI Bits

The UE may transmit the first UCI bit and the second UCI bit (for example, combined bits) by joint encoding. For example, a first HARQ-ACK codebook including the first UCI bit and a second HARQ-ACK codebook including the second UCI bit may be encoded together. Alternatively, the first UCI bit and the second UCI bit may be included in the same HARQ-ACK codebook to be jointly encoded.

Alternatively, the UE may transmit the first UCI bit and the second UCI bit (for example, combined bits) by separate encoding. For example, the first HARQ-ACK codebook including the first UCI bit and the second HARQ-ACK codebook including the second UCI bit may be separately encoded. In this case, an encoding condition (for example, code rate) applied to the first UCI bit and an encoding condition applied to the second UCI bit may be different. For example, the code rate of the first UCI bit may be controlled to be lower than the code rate of the second UCI bit.

### (Second Aspect)

In a second aspect, a description will be given as to another example of the UL transmission control in a case where a plurality of UL transmissions having different priorities overlap each other in the time domain.

In the second aspect, a case where the first PUCCH corresponding to the first priority (high) and the second PUCCH corresponding to the second priority (low) collide with each other, and the format of the first PUCCH and the format of the second PUCCH are less than a given value (for example, PUCCH format 0 or 1) will be described as an example. The PUCCH format being less than the given value may correspond to a PUCCH format capable of transmitting UCI of a given bit (for example, two bits) or less.

In this case, the UE may control the transmission of the UCI corresponding to each PUCCH based on at least one of the priorities corresponding to each PUCCH and the format of each PUCCH. The format of the first PUCCH and the format of the second PUCCH may be the same or different.

For example, the UE may control the UL transmission based on at least one of the following options 2-1 to 2-3. Hereinafter, a description will be given as to an option applicable by the UE for each format of the first PUCCH.

### Case in Which First PUCCH Format Is PF0

### [Option 2-1]

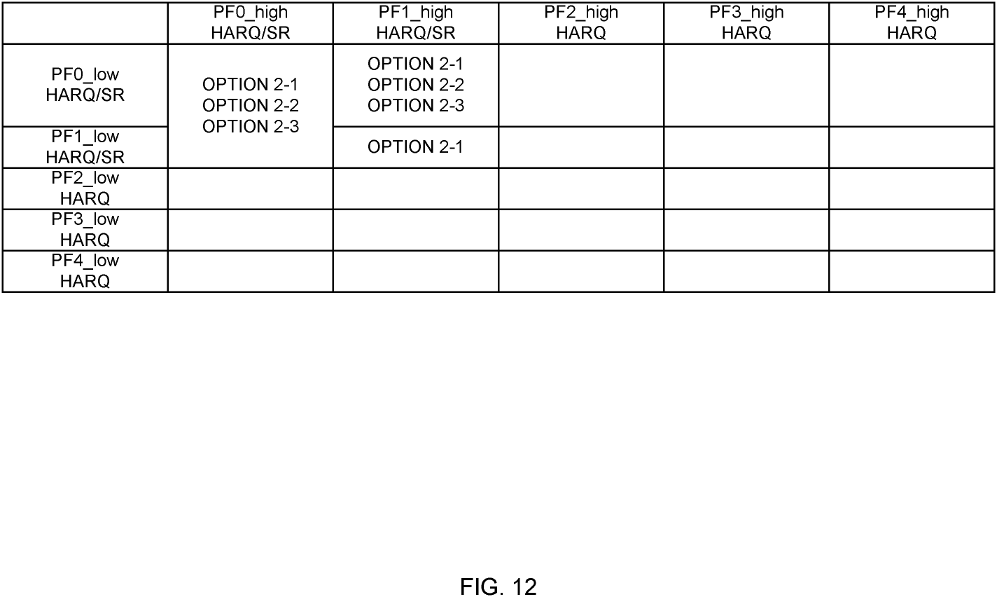

The UE may perform control to drop the UCI corresponding to the second PUCCH and to transmit the UCI corresponding to the first PUCCH using the first PUCCH (refer to FIG. 12). As described above, in a case where the bit size capable of being transmitted by the colliding first PUCCH and second PUCCH is two bits or less, UCI (or PUCCH) having a low priority is dropped. As a result, UCI having a high priority can be appropriately transmitted.

### [Option 2-2]

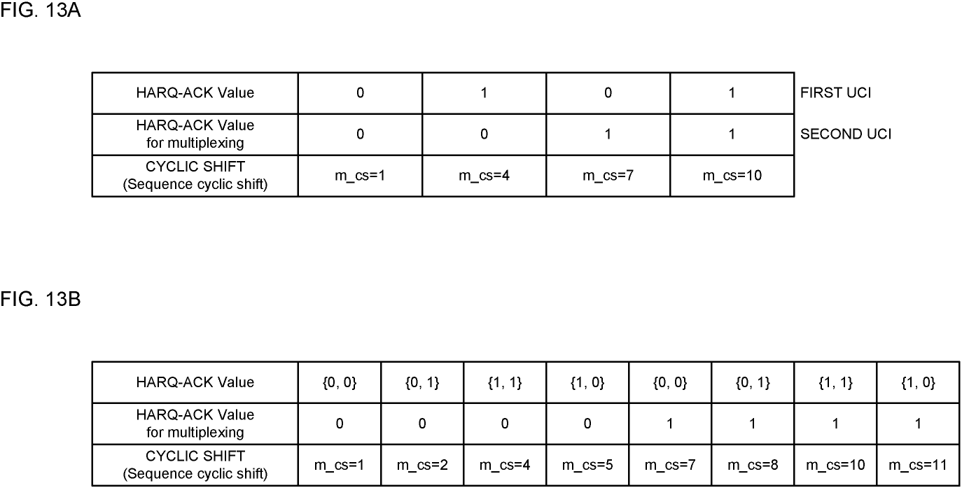

The UE may perform control to transmit the first UCI and the second UCI (for example, combined UCI) using the first PUCCH (PFO) resource. For example, the UE may transmit at least one of the first UCI (for example, HARQ-ACK) and the second UCI (for example, HARQ-ACK) using a cyclic shift of the first PUCCH resource (refer to FIGS. 13A and 13B).

FIG. 13A illustrates an example of a case where 1-bit first UCI and 1-bit second UCI are transmitted using the first PUCCH resource. Here, a case where a combination of the first UCI (for example, HARQ-ACK value) and the second UCI (for example, HARQ-ACK value for multiplexing) is associated with a given cyclic shift value (m_cs) is illustrated.

FIG. 13B illustrates an example of a case where the 2-bit first UCI and the 1-bit second UCI are transmitted using the first PUCCH resource. Here, a case where a combination of the first UCI (for example, HARQ-ACK value) and the second UCI (for example, HARQ-ACK value for multiplexing) is associated with a given cyclic shift value is illustrated.

When the number of bits of the second UCI is two bits, the UE may bundle the second UCI bits into one bit, and then perform transmission using the first PUCCH resource.

As described above, by transmitting the UCI using the cyclic shift, the first UCI and the second UCI can be transmitted even when PF0 having the small number of transmittable bits is used.

### [Option 2-3]

In the option 2-2, only when the number of first UCI bits is one, the UE may perform control to transmit the first UCI and the second UCI using the first PUCCH (PFO) resource (refer to FIG. 13A). When the number of bits of the second UCI is two bits, the UE may bundle the second UCI bits into one bit, and then perform transmission using the first PUCCH resource.

On the other hand, when the number of first UCI bits is two, control may be performed so that the UCI corresponding to the second PUCCH is dropped, and the UCI corresponding to the first PUCCH is transmitted using the first PUCCH. As a result, since the number of cyclic shifts used for the transmission of the first UCI and the second UCI can be reduced, the reliability of the first PUCCH transmission can be improved.

### Case in Which First PUCCH Format Is PF1

### [Option 2-1]

The UE may perform control to drop the UCI corresponding to the second PUCCH and to transmit the UCI corresponding to the first PUCCH using the first PUCCH (refer to FIG. 12). As described above, in a case where the bit size capable of being transmitted by the colliding first PUCCH and second PUCCH is two bits or less, UCI (or PUCCH) having a low priority is dropped. As a result, UCI having a high priority can be appropriately transmitted.

### [Option 2-2]

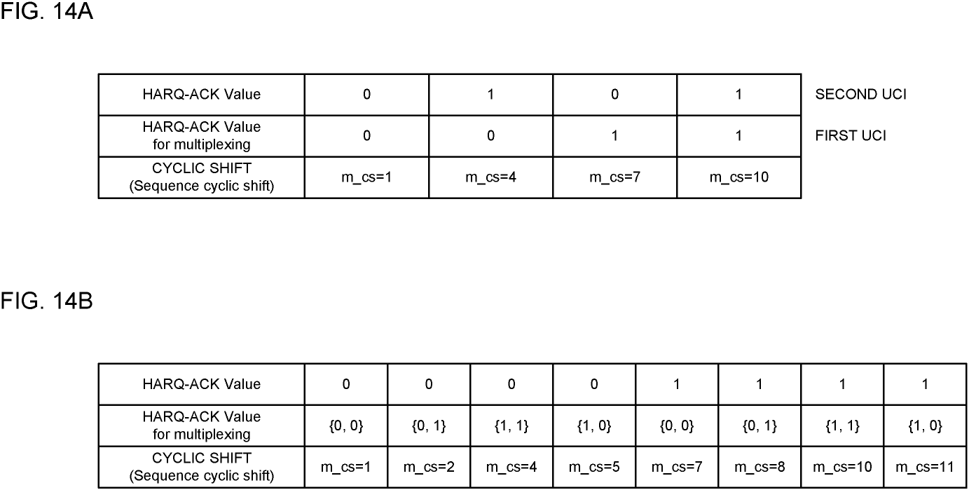

When the second PUCCH is PF0, the UE may perform control to transmit the first UCI and the second UCI (for example, combined UCI) using the second PUCCH (PFO) resource. For example, the UE may transmit at least one of the first UCI (for example, HARQ-ACK) and the second UCI (for example, HARQ-ACK) using the cyclic shift of the second PUCCH resource (refer to FIGS. 14A and 14B).

FIG. 14A illustrates an example of a case where 1-bit first UCI and 1-bit second UCI are transmitted using the second PUCCH resource. Here, a case where a combination of the second UCI (for example, HARQ-ACK value) and the first UCI (for example, HARQ-ACK value for multiplexing) is associated with a given cyclic shift value (m_cs) is illustrated.

FIG. 14B illustrates an example of a case in which the 2-bit first UCI and the 1-bit second UCI are transmitted using the second PUCCH resource. Here, a case where a combination of the second UCI (for example, HARQ-ACK value) and the first UCI (for example, HARQ-ACK value for multiplexing) is associated with a given cyclic shift value is illustrated.

When the number of bits of the second UCI is two bits, the UE may bundle the second UCI bits into one bit, and then perform transmission using the second PUCCH resource.

As described above, by transmitting the UCI using the cyclic shift, the first UCI and the second UCI can be transmitted even when PF0 having the small number of transmittable bits is used.

When the second PUCCH is PF1, the option 2-1 may be applied.

### [Option 2-3]

In the option 2-2, only when the number of first UCI bits is one, the UE may perform control to transmit the first UCI and the second UCI using the second PUCCH (PFO) resource (refer to FIG. 14A). When the number of bits of the second UCI is two bits, the UE may bundle the second UCI bits into one bit, and then perform transmission using the first PUCCH resource.

On the other hand, when the number of first UCI bits is two, control may be performed so that the UCI corresponding to the second PUCCH is dropped, and the UCI corresponding to the first PUCCH is transmitted using the first PUCCH. As a result, since the number of cyclic shifts used for the transmission of the first UCI and the second UCI can be reduced, the reliability of the first PUCCH transmission can be improved.

### (Third Aspect)

In a third aspect, a description will be given as to another example of the UL transmission control in a case where a plurality of UL transmissions having different priorities overlap each other in the time domain.

In the third aspect, a description will be given as an example as to a case where the first PUCCH corresponding to the first priority (high) and the second PUCCH corresponding to the second priority (low) collide with each other, the format of the first PUCCH is less than a given value (for example, PUCCH format 0 or 1), and the second PUCCH format is equal to or greater than the given value (for example, PUCCH format 2, 3, or 4).

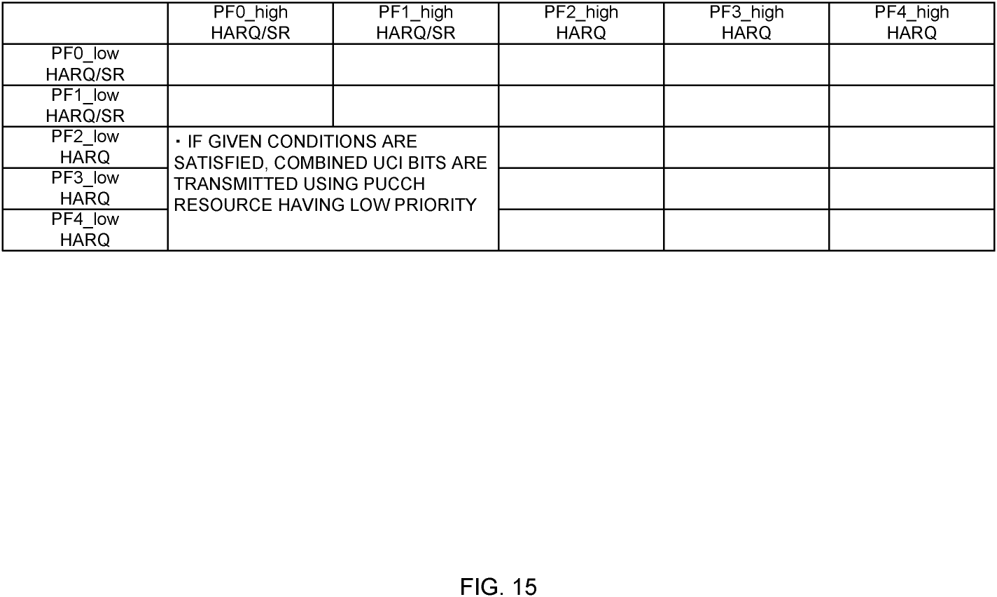

The UE may perform control to transmit the first UCI and the second UCI (for example, combined UCI) using the second PUCCH (or second PUCCH resource) when a given condition is satisfied (refer to FIG. 15). The given condition may be a relationship between transmission timings of the first PUCCH and the second PUCCH (for example, timeline).

For example, when at least one of the following condition 1 and condition 2 is satisfied, the UE may perform control to transmit the first UCI (or combined UCI) using the second PUCCH.

### Condition 1

The condition 1 may be a case in which a given symbol (for example, ending symbol) of the second PUCCH resource is arranged up to an X symbol after a given symbol (for example, ending symbol) of the colliding first PUCCH resource. X may be defined in the specification, or may be a value notified/configured from the base station to the UE by higher layer signaling or the like.

For example, X may be zero. In this case, the UE may transmit the first UCI using the second PUCCH when the ending symbol of the second PUCCH resource is arranged the same as or earlier in time direction as the ending symbol of the first PUCCH resource. Otherwise (for example, when the ending symbol of the first PUCCH resource is located the X symbol earlier than the ending symbol of the second PUCCH resource), the second PUCCH (or second UCI) may be dropped, and the first UCI may be transmitted using the first PUCCH. As a result, it is possible to suppress the delay of the first UCI having a high priority.

### Condition 2

The condition 2 may be a case in which a given symbol (for example, starting symbol) of the second PUCCH resource does not exceed a process timeline of the first priority (for example, first PUCCH/the first UCI). For example, the starting symbol of the second PUCCH resource and a starting symbol of the colliding first PUCCH resource may be arranged in a range of a Y symbol (or the starting symbol of the first PUCCH resource may be disposed within the Y symbol from the starting symbol of the second PUCCH resource).

This is because if the starting position of the second PUCCH resource is configured to be earlier than the starting position of the first PUCCH resource, the PDSCH corresponding to the first UCI (for example, HARQ-ACK) has not finished transmission, and it becomes difficult to multiplex the HARQ-ACK onto the second PUCCH. In this case, the second PUCCH (or second UCI) may be dropped, and the first UCI may be transmitted using the first PUCCH.

In a case where the condition 1 and the condition 2 are satisfied, the UE may dispose the first UCI closer to a reference signal (for example, DMRS) compared to the second UCI when transmitting the first UCI and the second UCI (for example, combined UCI) bits using the second PUCCH resource. In addition, the UE may perform a control operation so as to dispose the first UCI in an early symbol in the time domain.

### Determination of Second PUCCH Resource

When transmitting the first UCI bit and the second UCI bit (for example, combined UCI bits) using the second PUCCH, the UE may determine the second PUCCH resource using at least one of the option A-1 and the option A-2 shown in the first aspect. In the option A-1 and the option A-2 described in the first aspect, the first PUCCH may be replaced with the second PUCCH.

### Determination/Adjustment of Combined UCI Bits

When transmitting the first UCI bit and the second UCI bit (for example, combined UCI bits) using the second PUCCH, the UE may determine/adjust the number of bits of the combined UCI using at least one of the option B-1 and the option B-2 shown in the first aspect (for example, at least second UCI bit). Even when the second PUCCH resource is used, the second UCI bit having a low priority may be limited/adjusted (for example, bundled) to determine the combined UCI bits as in the first aspect.

### Encoding of Combined UCI Bits

When the UE transmits the first UCI bit and the second UCI bit (for example, combined bits) using the second PUCCH resource, the UE may apply joint encoding or separate encoding described in the first aspect.

### (Variations)

When the first UL transmission and the second UL transmission having different priorities overlap each other in the time domain, the UE may determine whether or not to apply the control methods described in the first to third aspects based on the given condition/given information.

For example, when given higher layer signaling is notified/configured, the UE may control multiplexing of the first UCI and the second UCI using at least one piece of UL control information described in the first aspect and the third aspect. For example, the UE perform control to transmit the first UCI and the second UCI (for example, combined UCI) bits using a given PUCCH resource when given higher layer signaling is notified/configured. Otherwise, control may be performed to transmit the first UCI using the first PUCCH, and to drop the second UCI (or second PUCCH).

For each combination/set of the format of the first PUCCH (PF #x) and the format of the second PUCCH (PF #y), whether or not to permit/support transmission of the first UCI and the second UCI using a given PUCCH resource may be separately configured. Alternatively, regardless of the combination/set of the format of the first PUCCH (PF #x) and the format of the second PUCCH (PF #y), whether or not to permit/support transmission of the first UCI and the second UCI using a given PUCCH resource may be configured in common.

Alternatively, whether or not to permit/support multiplexing (for example, transmission of combined UCI) of the first UCI and the second UCI may be dynamically indicated to the UE using the DCI. The UE may determine whether or not to transmit the combined UCI based on a value of a given field included in the DCI corresponding to each UCI (for example, HARQ-ACK). In this case, the values of the given fields of the DCI respectively corresponding to the HARQ-ACKs fed back at the same timing (or included in the same HARQ feedback window) may be configured to be the same.

Further, whether or not to dynamically notify the UE of the presence or absence of support of multiplexing (for example, transmission of combined UCI) of the first UCI and the second UCI may be instructed by higher layer signaling/DCI. For example, when given higher layer signaling (for example, higher layer signaling indicating dynamic multiplexing) is configured, the UE may determine that a given field indicating dynamic multiplexing is configured/present in the DCI. On the other hand, when the given higher layer signaling is not notified/configured, the UE may assume that the given field is not included in the DCI.

UE capability information (UE capability) indicating whether the UE supports multiplexing of the first UCI and the second UCI (for example, transmission of combined UCI), which is semi-statically/dynamically configured, may be defined.

In this case, UE capability information indicating whether multiplexing of the first UCI and the second UCI (for example, transmission of combined UCI) is supported may be separately defined for each combination/set of the format of the first PUCCH (PF #x) and the format of the second PUCCH (PF #y). Alternatively, regardless of the combination/set of the format of the first PUCCH (PF #x) and the format of the second PUCCH (PF #y), UE capability information indicating whether multiplexing of the first UCI and the second UCI (for example, transmission of combined UCI) is supported may be commonly defined.

### (Radio Communication System)

Hereinafter, a configuration of a radio communication system according to one embodiment of the present disclosure will be described. In this radio communication system, communication is performed using any one of the radio communication methods according to the embodiments of the present disclosure or a combination thereof.

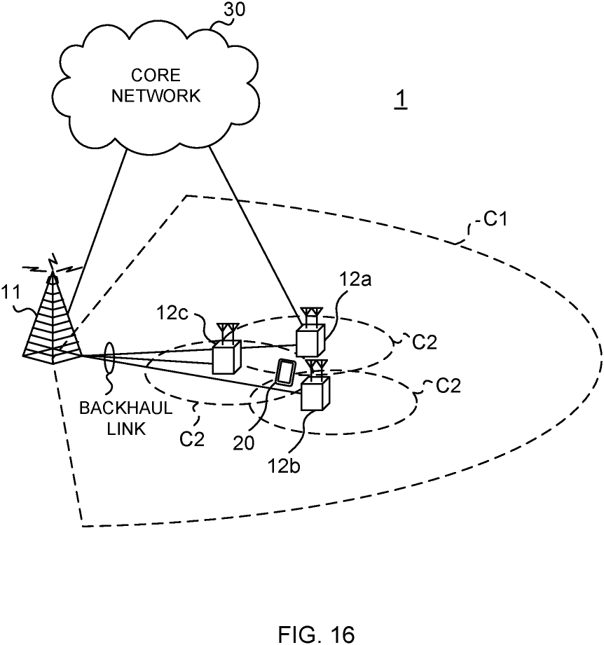

FIG. 16 is a diagram illustrating an example of a schematic configuration of the radio communication system according to one embodiment. A radio communication system 1 may be a system configured to implement communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, the NR base station (gNB) is the MN, and the LTE (E-UTRA) base station (eNB) is the SN.

The radio communication system 1 may support dual connectivity between a plurality of base stations in the same RAT (for example, dual connectivity in which both the MN and the SN are NR base stations (gNB) (NR-NR dual connectivity (NN-DC)).

The radio communication system 1 may include a base station 11 configured to form a macro cell C1 with a relatively wide coverage, and base stations 12 (12a to 12c) disposed within the macro cell C1 and configured to form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as “base stations 10” when the base stations 11 and 12 are not distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency range (frequency range 1 (FR1)) or a second frequency range (frequency range 2 (FR2)). The macro cell C1 may be included in the FR1, and the small cell C2 may be included in the FR2. For example, the FR1 may be a frequency range of 6 GHz or less (sub-6 GHz), and the FR2 may be a frequency range higher than 24 GHz (above-24 GHz). Note that the frequency bands, definitions, and the like of the FR1 and FR2 are not limited thereto, and, for example, the FR1 may correspond to a frequency band higher than the FR2.

Further, the user terminal 20 may perform communication in each CC using at least one of time division duplex (TDD) and frequency division duplex (FDD).

The plurality of base stations 10 may be connected to each other by wire (for example, an optical fiber or an X2 interface in compliance with common public radio interface (CPRI)) or wirelessly (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of an evolved packet core (EPC), a 5G core network (5GCN), and a next generation core (NGC).

The user terminal 20 may be a terminal that corresponds to at least one of communication methods such as LTE, LTE-A, and 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, as a downlink channel, a physical downlink shared channel (PDSCH), a physical broadcast channel (PBCH), a physical downlink control channel (PDCCH), or the like shared by the user terminals 20 may be used.

Further, in the radio communication system 1, as an uplink channel, a physical uplink shared channel (PUSCH), a physical uplink control channel (PUCCH), a physical random access channel (PRACH), or the like shared by the user terminals 20 may be used.

User data, higher layer control information, a system information block (SIB), and the like are transmitted on the PDSCH. The PUSCH may transmit the user data, higher layer control information, and the like. Furthermore, a master information block (MIB) may be transmitted on the PBCH.

Lower layer control information may be transmitted on the PDCCH. The lower layer control information may include, for example, downlink control information (DCI) including scheduling information of at least one of the PDSCH or the PUSCH.

Note that the DCI configured to schedule the PDSCH may be referred to as DL assignment, DL DCI, or the like, and the DCI configured to schedule PUSCH may be referred to as UL grant, UL DCI, or the like. Note that the PDSCH may be replaced with DL data, and the PUSCH may be replaced with UL data.

For detection of the PDCCH, a control resource set (CORESET) and a search space may be used. The CORESET corresponds to a resource configured to search for DCI. The search space corresponds to a search area and a search method for PDCCH candidates. One CORESET may be associated with one or more search spaces. The UE may monitor the CORESET associated with a given search space based on search space configuration.

One search space may correspond to a PDCCH candidate corresponding to one or more aggregation levels. One or more search spaces may be referred to as a search space set. Note that “search space” and “search space set”, “search space configuration” and “search space set configuration”, and “CORESET” and “CORESET configuration”, and the like in the present disclosure may be replaced with each other.

Uplink control information (UCI) including at least one of channel state information (CSI), delivery acknowledgement information (which may be referred to as, for example, hybrid automatic repeat request acknowledgement (HARQ-ACK), ACK/NACK, or the like), and scheduling request (SR) may be transmitted on the PUCCH. A random access preamble configured to establish connection with a cell may be transmitted on the PRACH.

Note that in the present disclosure, downlink, uplink, and the like may be expressed without “link”. Various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) and a secondary synchronization signal (SSS). A signal block including the SS (PSS or SSS) and the PBCH (and the DMRS for the PBCH) may be referred to as an SS/PBCH block, an SS block (SSB), or the like. Note that, the SS, the SSB, or the like may also be referred to as a reference signal.

Furthermore, in the radio communication system 1, a measurement reference signal (sounding reference signal (SRS)), a demodulation reference signal (DMRS), or the like may be transmitted as an uplink reference signal (UL-RS). Note that, DMRSs may be referred to as “user terminal-specific reference signals (UE-specific Reference Signals)”.

### (Base Station)

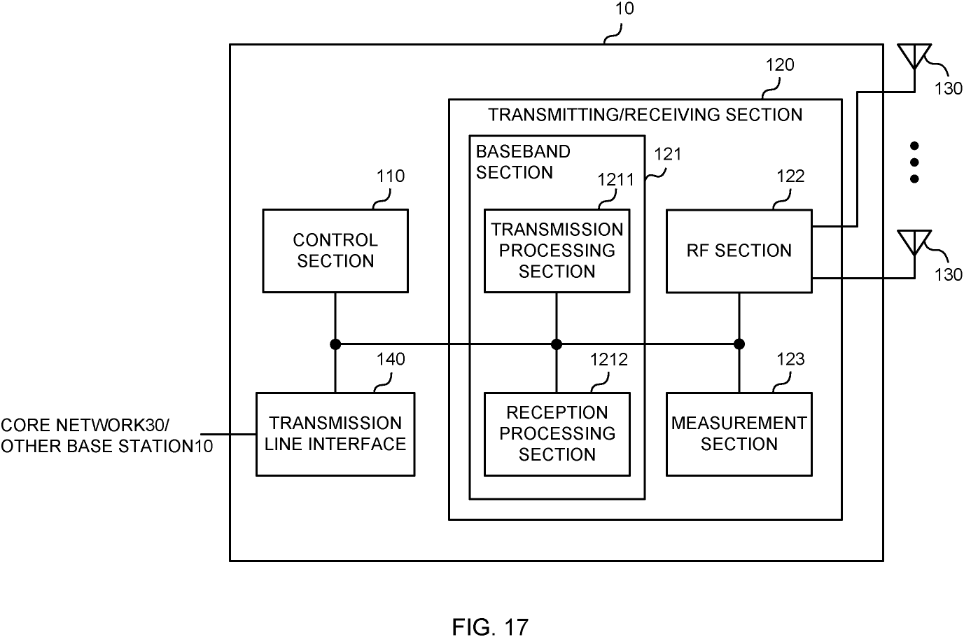

FIG. 17 is a diagram illustrating an example of a configuration of the base station according to one embodiment. The base station 10 includes a control section 110, a transmitting/receiving section 120, a transmission/reception antenna 130, and a transmission line interface 140. Note that one or more control sections 110, one or more transmitting/receiving sections 120, one or more transmission/reception antennas 130, and one or more transmission line interfaces 140 may be included.

Note that this example mainly describes a functional block which is a characteristic part of the present embodiment, and it may be assumed that the base station 10 also has another functional block necessary for radio communication. A part of processing of each section described below may be omitted.

The control section 110 controls the entire base station 10. The control section 110 can be implemented by a controller, a control circuit, and the like that are described based on common recognition in the technical field related to the present disclosure.

The control section 110 may control signal generation, scheduling (for example, resource allocation or mapping), and the like. The control section 110 may control transmission/reception, measurement, and the like using the transmitting/receiving section 120, the transmission/reception antenna 130, and the transmission line interface 140. The control section 110 may generate data to be transmitted as a signal, control information, a sequence, and the like, and may forward the data, the control information, the sequence, and the like to the transmitting/receiving section 120. The control section 110 may perform call processing (such as configuration or releasing) of a communication channel, management of the state of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can include a transmitter/receiver, an RF circuit, a baseband circuit, a filter, a phase shifter, a measurement circuit, a transmission/reception circuit, and the like that are described based on common recognition in the technical field related to the present disclosure.

The transmitting/receiving section 120 may be configured as an integrated transmitting/receiving section, or may be configured by a transmitting section and a receiving section. The transmitting section may include the transmission processing section 1211 and the RF section 122. The receiving section may be implemented by the reception processing section 1212, the RF section 122, and the measurement section 123.

The transmission/reception antennas 130 can be implemented by antennas described based on common recognition in the technical field related to the present disclosure, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a Tx beam and a reception beam using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmitting/receiving section 120 (transmission processing section 1211) may perform transmission processing such as channel encoding (which may include error correcting encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmitting/receiving section 120 (RF section 122) may perform modulation to a radio frequency band, filtering processing, amplification, and the like on the baseband signal, and may transmit a signal in the radio frequency band via the transmission/reception antenna 130.

Meanwhile, the transmitting/receiving section 120 (RF section 122) may perform amplification, filtering processing, demodulation to a baseband signal, and the like on the signal in the radio frequency band received by the transmission/reception antenna 130.

The transmitting/receiving section 120 (reception processing section 1212) may apply reception processing such as analog-digital conversion, fast fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 120 (measurement section 123) may perform measurement on the received signal. For example, the measurement section 123 may perform radio resource management (RRM), channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may transmit/receive a signal (backhaul signaling) to and from an apparatus included in the core network 30, other base stations 10, and the like, and may acquire, transmit user data (user plane data), control plane data, and the like for the user terminal 20.

Note that the transmitting section and the receiving section of the base station 10 in the present disclosure may include at least one of the transmitting/receiving section 120, the transmission/reception antenna 130, and the transmission line interface 140.

The transmitting/receiving section 120 may transmit information related to the priority corresponding to the physical uplink control channel.

When a plurality of the physical uplink control channels having different priorities overlap each other in the time domain, the control section 110 may control reception of the uplink control information transmitted using a given physical uplink control channel selected based on the format of each physical uplink control channel in the terminal.

### (User Terminal)

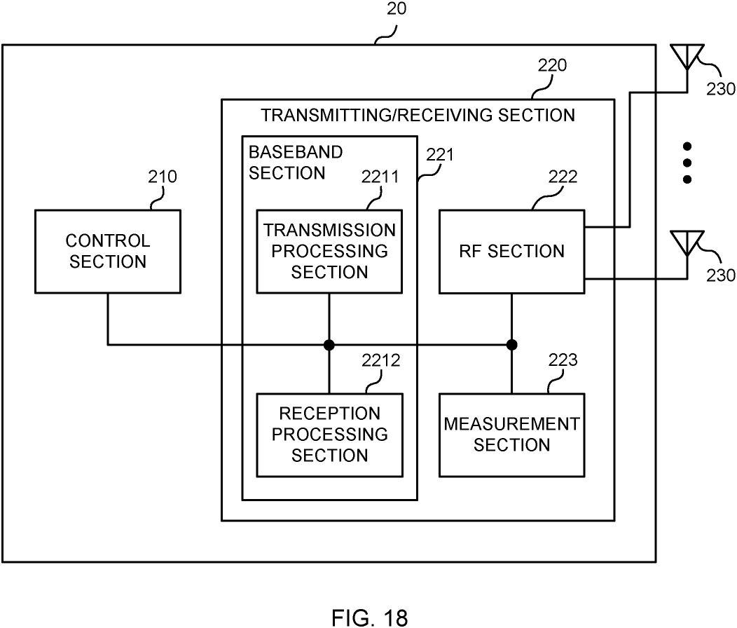

FIG. 18 is a diagram illustrating an example of a configuration of the user terminal according to one embodiment. The user terminal 20 includes a control section 210, a transmitting/receiving section 220, and a transmission/reception antenna 230. Note that one or more of the control sections 210, one or more of the transmitting/receiving sections 220, and one or more of the transmission/reception antennas 230 may be included.

Note that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can include a controller, a control circuit, and the like that are described based on common recognition in the technical field related to the present disclosure.

The control section 210 may control signal generation, mapping, and the like. The control section 210 may control transmission/reception, measurement, and the like using the transmitting/receiving section 220 and the transmission/reception antenna 230. The control section 210 may generate data, control information, a sequence, and the like to be transmitted as signals, and may forward the data, the control information, the sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be implemented by a transmitter/receiver, an RF circuit, a baseband circuit, a filter, a phase shifter, a measurement circuit, a transmitting/receiving circuit, and the like that are described based on common recognition in the technical field related to the present disclosure.

The transmitting/receiving section 220 may be formed as an integrated transmitting/receiving section, or may include a transmitting section and a receiving section. The transmitting section may include the transmission processing section 2211 and the RF section 222. The receiving section may include the reception processing section 2212, the RF section 222, and the measurement section 223.

The transmission/reception antenna 230 can include an antenna described based on common recognition in the technical field related to the present disclosure, for example, an array antenna.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a Tx beam and a reception beam using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like on, for example, data, control information, and the like acquired from the control section 210, to generate a bit string to be transmitted.

The transmitting/receiving section 220 (transmission processing section 2211) may perform transmission processing such as channel encoding (which may include error correcting encoding), modulation, mapping, filtering processing, DFT processing (if necessary), IFFT processing, precoding, or digital-analog conversion on the bit string to be transmitted, to output a baseband signal.

Note that whether or not to apply DFT processing may be determined based on configuration of transform precoding. In a case where transform precoding is enabled for a given channel (for example, PUSCH), the transmitting/receiving section 220 (transmission processing section 2211) may perform DFT processing as the transmission processing in order to transmit the channel using a DFT-s-OFDM waveform, and otherwise, DFT processing may not be performed as the transmission processing.

The transmitting/receiving section 220 (RF section 222) may perform modulation to a radio frequency range, filtering processing, amplification, and the like on the baseband signal, to transmit a signal in the radio frequency range via the transmission/reception antenna 230.

Meanwhile, the transmitting/receiving section 220 (RF section 222) may perform amplification, filtering processing, demodulation to a baseband signal, and the like on the signal in the radio frequency range received by the transmission/reception antenna 230.

The transmitting/receiving section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmitting section and the receiving section of the user terminal 20 in the present disclosure may include at least one of the transmitting/receiving section 220 and the transmission/reception antenna 230.

The transmitting/receiving section 220 may receive information related to the priority corresponding to the physical uplink control channel.

When a plurality of physical uplink control channels having different priorities overlap each other in the time domain, the control section 210 may determine, based on the format of each physical uplink control channel, whether or not to transmit the uplink control information corresponding to each physical uplink control channel and the physical uplink control channel used for transmitting the uplink control information corresponding to each physical uplink control channel.

When the plurality of physical uplink control channels includes a first physical uplink control channel and a second physical uplink control channel having a lower priority than the first physical uplink control channel, and the format of the first physical uplink control channel is greater than or equal to a given value, the control section 210 may perform control to transmit the uplink control information corresponding to the second physical uplink control channel using the first physical uplink control channel.

When the plurality of physical uplink control channels includes the first physical uplink control channel and the second physical uplink control channel having a lower priority than the first physical uplink control channel, and the formats of the first physical uplink control channel and the second physical uplink control channel are smaller than the given value, the control section 210 may perform a control operation so as to transmit the uplink control information corresponding to the first physical uplink control channel or the uplink control information corresponding to the second physical uplink control channel using a cyclic shift.

When the plurality of physical uplink control channels includes the first physical uplink control channel and the second physical uplink control channel having a lower priority than the first physical uplink control channel, the format of the first physical uplink control channel is smaller than a given value, and the format of the second physical uplink control channel is greater than or equal to the given value, the control section 210 may perform control to transmit the uplink control information corresponding to the first physical uplink control channel using the second physical uplink control channel.

### (Hardware Configuration)

Note that the block diagrams that have been used to describe the above embodiments illustrate blocks in functional units. These functional blocks (components) may be implemented in any combinations of at least one of hardware and software. Further, the method of implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional block may be implemented by combining the one apparatus or the plurality of apparatuses with software.

Here, the functions include, but are not limited to, judging, determination, decision, calculation, computation, processing, derivation, investigation, search, confirmation, reception, transmission, output, access, solution, selection, choosing, establishment, comparison, assumption, expectation, deeming, broadcasting, notifying, communicating, forwarding, configuring, reconfiguring, allocating, mapping, assigning, and the like. For example, a functional block (component) that has a transmission function may be referred to as a transmitting section (transmitting unit), a transmitter, and the like. In any case, as described above, the implementation method is not particularly limited.

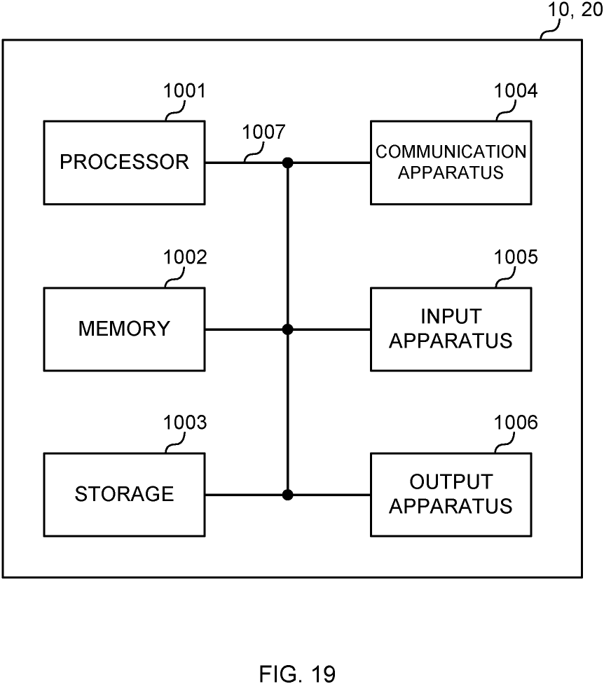

For example, the base station, the user terminal, and the like according to one embodiment of the present disclosure may function as a computer configured to execute the processing of the radio communication method of the present disclosure. FIG. 19 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, and a unit can be read as interchangeable with each other. The hardware configuration of the base station 10 and the user terminal 20 may be designed to include one or more of the apparatuses illustrated in the drawings, or may be designed not to include some apparatuses.

For example, although only one processor 1001 is illustrated, a plurality of processors may be provided. Further, the processing may be executed by one processor, or the processing may be executed by two or more processors simultaneously or sequentially, or using other methods. Note that the processor 1001 may be implemented with one or more chips.

Each function of the base station 10 and the user terminal 20 is implemented by, for example, reading given software (program) onto hardware such as the processor 1001 and the memory 1002, and by controlling the operation in the processor 1001, the communication in the communication apparatus 1004, and at least one of the reading or writing of data in the memory 1002 and the storage 1003.

The processor 1001 may control the whole computer by, for example, running an operating system. The processor 1001 may be implemented by a central processing unit (CPU) including an interface with peripheral equipment, a control apparatus, an operation apparatus, a register, and the like. For example, at least a part of the above-described control section 110 (210), transmitting/receiving section 120 (220), and the like may be implemented by the processor 1001.

Furthermore, the processor 1001 reads programs (program codes), software modules, data, and the like from at least one of the storage 1003 and the communication apparatus 1004 into the memory 1002, and executes various processing according to these. As the program, a program that causes a computer to execute at least a part of the operation described in the above-described embodiment is used. For example, the control section 110 (210) may be implemented by control programs stored in the memory 1002 and configured to operate on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), or other appropriate storage media. The memory 1002 may be referred to as a register, a cache, a main memory (primary storage apparatus), and the like. The memory 1002 can store a program (program code), a software module, and the like executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disk, a Blu-ray (registered trademark) disk), a removable disk, a hard disk drive, a smart card, a flash memory device (for example, a card, a stick, or a key drive), a magnetic stripe, a database, a server, or other appropriate storage media. The storage 1003 may be referred to as “secondary storage apparatus”.

The communication apparatus 1004 is hardware (transmission/reception device) for performing inter-computer communication via at least one of a wired network and a radio network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) or time division duplex (TDD). For example, the transmitting/receiving section 120 (220), the transmission/reception antenna 130 (230), and the like described above may be implemented by the communication apparatus 1004. The transmitting/receiving section 120 (220) may be implemented by physically or logically separating the transmitting section 120a (220a) and the receiving section 120b (220b) from each other.

The input apparatus 1005 is an input device configured to receive input from the outside (for example, a keyboard, a mouse, a microphone, a switch, a button, a sensor and the like). The output apparatus 1006 is an output device configured to perform output to the outside (for example, a display, a speaker, a light emitting diode (LED) lamp, or the like). Note that the input apparatus 1005 and the output apparatus 1006 may be provided in an integrated structure (for example, a touch panel).

Furthermore, these pieces of apparatus, including the processor 1001, the memory 1002 and the like are connected by the bus 1007 so as to communicate information. The bus 1007 may be formed with a single bus, or may be formed with buses that vary between pieces of apparatus.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented using the hardware. For example, the processor 1001 may be implemented with at least one of these pieces of hardware.

### (Modification)

Note that terms described in the present disclosure and terms necessary for understanding the present disclosure may be replaced with terms that have the same or similar meanings. For example, a channel, a symbol, and a signal (signal or signaling) may be replaced with each other. Further, the signal may be a message. The reference signal can be abbreviated to an RS, and may be referred to as a pilot, a pilot signal, and the like, depending on which standard applies. Further, a component carrier (CC) may be referred to as a cell, a frequency carrier, a carrier frequency, and the like.

A radio frame may include one or more periods (frames) in the time domain. Each of the one or more periods (frames) included in the radio frame may be referred to as a subframe. Further, the subframe may include one or more slots in the time domain. The subframe may be a fixed time duration (for example, 1 ms) that is not dependent on numerology.

Here, the numerology may be a communication parameter used for at least one of transmission and reception of a given signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transmitter/receiver in the frequency domain, specific windowing processing performed by a transmitter/receiver in the time domain, and the like.

The slot may include one or more symbols in the time domain (orthogonal frequency division multiplexing (OFDM) symbols, single carrier frequency division multiple access (SC-FDMA) symbols, and the like). Further, a slot may be a time unit based on numerology.

The slot may include a plurality of mini slots. Each mini slot may include one or more symbols in the time domain. Further, the mini slot may be referred to as a subslot. Each mini slot may include fewer symbols than the slot. A PDSCH (or PUSCH) transmitted in a time unit larger than the mini slot may be referred to as PDSCH (PUSCH) mapping type A. A PDSCH (or PUSCH) transmitted using the mini slot may be referred to as PDSCH (PUSCH) mapping type B.

A radio frame, a subframe, a slot, a mini slot and a symbol all represent the time unit in signal communication. The radio frame, the subframe, the slot, the mini slot, and the symbol may be called by other applicable names, respectively. Note that time units such as the frame, the subframe, the slot, the mini slot, and the symbol in the present disclosure may be read as interchangeable with each other.

For example, one subframe may be referred to as TTI, a plurality of consecutive subframes may be referred to as TTI, or one slot or one mini slot may be referred to as TTI. That is, at least one of the subframe and the TTI may be a subframe (1 ms) in the existing LTE, may be a period shorter than 1 ms (for example, one to thirteen symbols), or may be a period longer than 1 ms. Note that the unit representing the TTI may be referred to as a slot, a mini slot and so on, instead of a subframe.

Here, a TTI refers to the minimum time unit of scheduling in radio communication, for example. For example, in the LTE system, a base station performs scheduling to allocate radio resources (a frequency bandwidth, transmission power, and the like that can be used in each user terminal) to each user terminal in TTI units. Note that the definition of TTI is not limited to this.

The TTI may be a transmission time unit such as a channel-coded data packet (transport block), a code block, a codeword, or the like, or may be a processing unit such as scheduling or link adaptation. Note that when TTI is given, a time interval (for example, the number of symbols) in which the transport blocks, the code blocks, the codewords, and the like are actually mapped may be shorter than TTI.

Note that, when one slot or one mini slot is referred to as a TTI, one or more TTIs (that is, one or more slots or one or more mini slots) may be the minimum time unit of scheduling. Further, the number of slots (the number of mini slots) to constitute this minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini slot, a subslot, a slot, or the like.

Note that a long TTI (for example, a normal TTI, a subframe, and the like) may be replaced with a TTI having a time duration exceeding 1 ms, and a short TTI (for example, a shortened TTI) may be replaced with a TTI having a TTI duration less than the TTI duration of a long TTI and not less than 1 ms.

A resource block (RB) is the unit of resource allocation in the time domain and the frequency domain, and may include one or more continuous subcarriers in the frequency domain. The number of subcarriers included in the RB may be the same regardless of the numerology, and may be twelve, for example. The number of subcarriers included in the RB may be determined based on numerology.

Further, an RB may include one or more symbols in the time domain, and may be one slot, one mini slot, one subframe or one TTI in length. One TTI, one subframe, and the like may each include one or more resource blocks.

Note that one or more RBs may be referred to as a physical resource block (physical RB(PRB)), a sub-carrier group (SCG), a resource element group (REG), a PRB pair, an RB pair, and the like.

Furthermore, a resource block may include one or more resource elements (REs). For example, one RE may be a radio resource field of one subcarrier and one symbol.

A bandwidth part (BWP) (which may be referred to as a partial bandwidth or the like) may represent a subset of continuous common resource blocks (RBs) for a given numerology in a given carrier. Here, the common RB may be specified by the index of the RB based on a common reference point of the carrier. A PRB may be defined in a given BWP and numbered within the BWP.

The BWP may include a BWP for UL (UL BWP) and a BWP for DL (DL BWP). For the UE, one or more BWPs may be configured within one carrier.

At least one of the configured BWPs may be active, and the UE need not expect to transmit or receive a given signal/channel outside the active BWP. Note that, a “cell”, a “carrier”, and the like in the present disclosure may be read as interchangeable with a “BWP”.

Note that the structures of radio frames, subframes, slots, mini slots, symbols and the like described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

Furthermore, the information and parameters described in the present disclosure may be represented in absolute values, represented in relative values with respect to given values, or represented using other corresponding information. For example, a radio resource may be specified by a given index.

Names used for, for example, parameters in the present disclosure are in no respect limitative. Further, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not limitative names in any respect.

The information, signals, and the like described in the present disclosure may be represented using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Further, information, signals, and the like can be output in at least one of a direction from higher layers to lower layers and a direction from lower layers to higher layers. Information, signals, and the like may be input and output via a plurality of network nodes.

The information, signals, and the like that are input and/or output may be stored in a specific location (for example, in a memory), or may be managed in a control table. The information, signals, and the like to be input and output can be overwritten, updated, or appended. The output information, signals, and the like may be deleted. The information, signals and the like that are input may be transmitted to other pieces of apparatus.

Notification of information may be performed not only using the aspects/embodiments described in the present disclosure but also using another method. For example, the notification of information in the present disclosure may be performed using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message, and the like. Further, notification of the MAC signaling may be performed using, for example, an MAC control element (CE).

Also, notification of given information (for example, notification of information to the effect that “X holds”) does not necessarily have to be sent explicitly, and can be sent implicitly (for example, by not performing notification of the given information or by performing notification of another piece of information).

Decisions may be made in values represented by 1 bit (0 or 1), may be made in Boolean values that represent true or false, or may be made by comparing numerical values (for example, comparison against a given value).

Software, regardless whether referred to as “software”, “firmware”, “middleware”, “microcode” or “hardware description language”, or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Additionally, software, instructions, information and the like may be transmitted and received via communication media. For example, when software is transmitted from a website, a server, or another remote source using at least one of a wired technology (coaxial cable, optical fiber cable, twisted pair, digital subscriber line (DSL), or the like) and a radio technology (infrared rays, microwaves, and the like), at least one of the wired technology and the wireless technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station or the base station subsystem that performs a communication service in this coverage.

In the present disclosure, the terms such as “mobile station (MS)”, “user terminal”, “user equipment (UE)”, and “terminal” can be used interchangeably.

A mobile station may be referred to as a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

At least one of the base station and mobile station may be called as a transmitting apparatus, a reception apparatus, a radio communication apparatus, and the like. Note that at least one of the base station and the mobile station may be a device mounted on a moving object, a moving object itself, and the like. The moving object may be a transportation (for example, a car, an airplane, or the like), an unmanned moving object (for example, a drone, an autonomous car, or the like), or a (manned or unmanned) robot. Note that at least one of the base station and the mobile station also includes a device that does not necessarily move during a communication operation. For example, at least one of the base station and the mobile station may be an Internet of Things (IoT) device such as a sensor.

Further, the base station in the present disclosure may be read as interchangeable with the user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. Further, terms such as “uplink” and “downlink” may be replaced with terms corresponding to communication between terminals (for example, “side”). For example, an uplink channel and a downlink channel may be read as interchangeable with a side channel.

Likewise, the user terminal in the present disclosure may be read as interchangeable with the base station. In this case, the base station 10 may be configured to have the functions of the user terminal 20 described above.

In the present disclosure, an operation performed by the base station may be performed by an upper node thereof in some cases. In a network including one or more network nodes with base stations, it is clear that various operations performed for communication with a terminal can be performed by a base station, one or more network nodes (examples of which include but are not limited to mobility management entity (MME) and serving-gateway (S-GW)) other than the base station, or a combination thereof.

The aspects/embodiments described in the present disclosure may be used individually or in combinations, which may be switched depending on the mode of implementation. Further, the order of processing procedures, sequences, flowcharts, and the like of the aspects/embodiments described in the present disclosure may be re-ordered as long as there is no inconsistency. For example, although various methods have been illustrated in the present disclosure with various components of steps using exemplary orders, the specific orders that are illustrated herein are by no means limitative.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (x is, for example, an integer or decimal), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded based on these, and the like. Further, a plurality of systems may be combined and applied (for example, a combination of LTE or LTE-A and 5G, and the like).

The phrase “based on” as used in the present disclosure does not mean “based only on”, unless otherwise specified. In other words, the phrase “based on” means both “based only on” and “based at least on”.

Reference to elements with designations such as “first”, “second”, and the like as used in the present disclosure does not generally limit the number/quantity or order of these elements. These designations can be used in the present disclosure, as a convenient way of distinguishing between two or more elements. In this way, reference to the first and second elements does not mean that only two elements may be employed, or that the first element must precede the second element in some way.

The term “determining” as used in the present disclosure may encompass a wide variety of operations. For example, “determining” may be regarded as judging, calculating, computing, processing, deriving, investigating, looking up, search, inquiry (for example, looking up in a table, database, or another data structure), ascertaining, and the like.

Furthermore, to “determine” as used herein may be interpreted to mean making determinations related to receiving (for example, receiving information), transmitting (for example, transmitting information), inputting, outputting, accessing (for example, accessing data in a memory) and so on.

In addition, to “determine” as used herein may be interpreted to mean making determinations related to resolving, selecting, choosing, establishing, comparing and so on. In other words, to “determine” as used herein may be interpreted to mean making determinations related to some action.

In addition, “determine” as used herein may be read as interchangeable with “assuming”, “expecting”, “considering”, or the like.

The “maximum transmission power” described in the present disclosure may mean a maximum value of transmission power, nominal UE maximum transmit power, or rated UE maximum transmit power.

As used in the present disclosure, the terms “connected” and “coupled”, or any variation of these terms mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be read as interchangeable with “access”.

As used in the present disclosure, when two elements are connected, these elements may be considered “connected” or “coupled” to each other using one or more electrical wires, cables, printed electrical connections, and the like, and, as a number of non-limiting and non-inclusive examples, using electromagnetic energy having wavelengths in the radio frequency domain, the microwave region, and the optical (both visible and invisible) region, or the like.

In the present disclosure, the phrase “A and B are different” may mean “A and B are different from each other”. Note that the phrase may mean that “A and B are different from C”. The terms such as “separated”, “coupled”, and the like may be similarly interpreted as “different”.

When the terms such as “include”, “including”, and variations of these are used in the present disclosure, these terms are intended to be inclusive, in a manner similar to the way the term “comprising” is used. Furthermore, the term “or” as used in the present disclosure is intended to be not an exclusive-OR.

In the present disclosure, when articles, such as “a”, “an”, and “the” are added in English translation, the present disclosure may include the plural forms of nouns that follow these articles.

Now, although the invention according to the present disclosure has been described in detail above, it is obvious to a person skilled in the art that the invention according to the present disclosure is by no means limited to the embodiments described in the present disclosure. The invention according to the present disclosure can be embodied with various corrections and in various modified aspects, without departing from the spirit and scope of the invention defined based on the description of claims. Thus, the description of the present disclosure is for the purpose of explaining examples and does not bring any limiting meaning to the invention according to the present disclosure.

What is claimed is:

1. A terminal comprising:
a receiving section configured to receive information on a priority corresponding to a physical uplink control channel; and
a control section configured to, when a plurality of the physical uplink control channels having different priorities overlap each other in a time domain, determine, based on a format of each physical uplink control channel, whether or not to transmit uplink control information corresponding to each physical uplink control channel, and the physical uplink control channel to be used for transmission of the uplink control information corresponding to each physical uplink control channel.

2. The terminal according to claim 1, wherein, when the plurality of physical uplink control channels includes a first physical uplink control channel and a second physical uplink control channel having a lower priority than a priority of the first physical uplink control channel, and a format of the first physical uplink control channel is equal to or greater than a given value, the control section performs control to transmit the uplink control information corresponding to the second physical uplink control channel using the first physical uplink control channel.

3. The terminal according to claim 1, wherein, when the plurality of physical uplink control channels includes a first physical uplink control channel and a second physical uplink control channel having a lower priority than a priority of the first physical uplink control channel, and formats of the first physical uplink control channel and the second physical uplink control channel are smaller than a given value, the control section performs control to transmit the uplink control information corresponding to the first physical uplink control channel or the uplink control information corresponding to the second physical uplink control channel using a cyclic shift.

4. The terminal according to claim 1, wherein, when the plurality of physical uplink control channels includes a first physical uplink control channel and a second physical uplink control channel having a lower priority than a priority of the first physical uplink control channel, and a format of the first physical uplink control channel is smaller than a given value and a format of the second physical uplink control channel is equal to or greater than the given value, the control section performs control to transmit the uplink control information corresponding to the first physical uplink control channel using the second physical uplink control channel.

5. A radio communication method of a terminal, the method comprising:
receiving information on a priority corresponding to a physical uplink control channel; and
determining, when a plurality of the physical uplink control channels having different priorities overlap each other in a time domain, whether or not to transmit uplink control information corresponding to each physical uplink control channel, and the physical uplink control channel to be used for transmission of the uplink control information corresponding to each physical uplink control channel based on a format of each physical uplink control channel.

6. A base station comprising:
a transmitting section configured to transmit information on a priority corresponding to a physical uplink control channel; and
a control section configured to, when a plurality of the physical uplink control channels having different priorities overlap each other in a time domain, control reception of uplink control information transmitted using a given physical uplink control channel selected based on a format of each physical uplink control channel in a terminal.

7. The terminal according to claim 2, wherein, when the plurality of physical uplink control channels includes a first physical uplink control channel and a second physical uplink control channel having a lower priority than a priority of the first physical uplink control channel, and formats of the first physical uplink control channel and the second physical uplink control channel are smaller than a given value, the control section performs control to transmit the uplink control information corresponding to the first physical uplink control channel or the uplink control information corresponding to the second physical uplink control channel using a cyclic shift.

8. The terminal according to claim 2, wherein, when the plurality of physical uplink control channels includes a first physical uplink control channel and a second physical uplink control channel having a lower priority than a priority of the first physical uplink control channel, and a format of the first physical uplink control channel is smaller than a given value and a format of the second physical uplink control channel is equal to or greater than the given value, the control section performs control to transmit the uplink control information corresponding to the first physical uplink control channel using the second physical uplink control channel.

9. The terminal according to claim 3, wherein, when the plurality of physical uplink control channels includes a first physical uplink control channel and a second physical uplink control channel having a lower priority than a priority of the first physical uplink control channel, and a format of the first physical uplink control channel is smaller than a given value and a format of the second physical uplink control channel is equal to or greater than the given value, the control section performs control to transmit the uplink control information corresponding to the first physical uplink control channel using the second physical uplink control channel.
